(19) United States
(12) Patent Application Publication
(10) Pub. No.: US 2024/0296365 A1
(43) Pub. Date: Sep. 5, 2024

(54) NOISE LEARNING IN DYNAMIC QUANTUM CIRCUITS

(71) Applicant: International Business Machines Corporation, Armonk, NY (US)

(72) Inventors: Paul Kristan Temme, Ossining, NY (US); Ewout van den Berg, Bronxville, NY (US); Riddhi Swaroop Gupta, San Jose, CA (US); Abhinav Kandala, Yorktown Heights, NY (US)

(21) Appl. No.: 18/178,240

(22) Filed: Mar. 3, 2023

(51) Int. Cl. G06N 10/40; G06N 10/20

(52) U.S. Cl. CPC G06N 10/40; G06N 10/20

(57) ABSTRACT

Systems and techniques that facilitate noise learning in dynamic quantum circuits are provided. In various embodiments, a system can learn noise associated with a mid-circuit non-unitary operation of a dynamic quantum circuit, by modifying the mid-circuit non-unitary operation with a probabilistic Pauli-Z gate and twirled Pauli operators.

### GOVERNMENT LICENSE RIGHTS

This invention was made with government support under W911NF-21-1-0002 awarded by the Army Research Office. The government has certain rights to this invention.

### BACKGROUND

The subject disclosure relates to quantum circuits, and more specifically to noise learning in dynamic quantum circuits.

A dynamic quantum circuit can be a quantum circuit that contains one or more mid-circuit non-unitary operations, such as mid-circuit qubit measurements that feed forward to classically-controlled quantum gates. Dynamic quantum circuits can be considered as more computationally powerful and versatile than regular quantum circuits. Unfortunately, however, noise in dynamic quantum circuits is poorly understood, which has led to a dearth of effective error mitigation or suppression techniques for dynamic quantum circuits. Indeed, existing error mitigation or suppression techniques are effectively or efficaciously compatible only with regular quantum circuits, where all non-unitary operations are pushed to the end of the circuit. Such existing error mitigation or suppression techniques are incompatible with mid-circuit non-unitary operations.

Accordingly, systems or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate noise learning in dynamic quantum circuits are described.

According to one or more embodiments, a system is provided. In various aspects, the system can comprise a processor that can execute computer-executable components stored in a non-transitory computer-readable memory. In various instances, the computer-executable components can comprise a learning component that can learn noise associated with a mid-circuit non-unitary operation of a dynamic quantum circuit, by modifying the mid-circuit non-unitary operation with a probabilistic Pauli-Z gate and twirled Pauli operators.

According to one or more embodiments, a computer-implemented method is provided. In various aspects, the computer-implemented method can comprise learning, by a device operatively coupled to a processor, noise associated with a mid-circuit non-unitary operation of a dynamic quantum circuit, by modifying the mid-circuit non-unitary operation with a probabilistic Pauli-Z gate and twirled Pauli operators.

According to one or more embodiments, a computer program product for facilitating noise learning in dynamic quantum circuits is provided. In various aspects, the computer program product can comprise a non-transitory computer-readable memory having program instructions embodied therewith. In various instances, the program instructions can be executable by a processor to cause the processor to learn noise associated with a mid-circuit non-unitary operation of a dynamic quantum circuit, by modifying the mid-circuit non-unitary operation with a probabilistic Pauli-Z gate and twirled Pauli operators.

Various other details of various embodiments described herein are provided in the following clauses:

CLAUSE 1: A system, comprising: a processor that executes computer-executable components stored in a non-transitory computer-readable memory, wherein the computer-executable components comprise: a learning component that learns noise associated with a mid-circuit non-unitary operation of a dynamic quantum circuit, by modifying the mid-circuit non-unitary operation with a probabilistic Pauli-Z gate and twirled Pauli operators.

CLAUSE 2: The system of any preceding clause, wherein the mid-circuit non-unitary operation comprises a mid-circuit qubit measurement that feeds forward to at least one classically-controlled quantum gate.

CLAUSE 3: The system of any preceding clause, wherein the at least one classically-controlled quantum gate is between the twirled Pauli operators.

CLAUSE 4: The system of any preceding clause, wherein the at least one classically-controlled quantum gate is not between the twirled Pauli operators.

CLAUSE 5: The system of any preceding clause, wherein the learning component learns the noise by repeatedly executing, across a set of Pauli bases and across a set of repetition depths, the mid-circuit non-unitary operation as modified with the probabilistic Pauli-Z gate and the twirled Pauli operators and extracting, based on such repeated executions, a set of basis fidelities respectively corresponding to the set of Pauli bases.

CLAUSE 6: The system of any preceding clause, wherein the learning component learns the noise associated with the mid-circuit non-unitary operation, by inverting the set of basis fidelities via commutation relations defined between the set of Pauli bases and a set of Pauli generators associated with the noise.

CLAUSE 7: The system of any preceding clause, wherein the computer-executable components further comprise: a mitigation component that mitigates the noise by inserting an inverse of the noise into the dynamic quantum circuit.

In various aspects, any combination or combinations of any of clauses 1-7 can be implemented.

CLAUSE 8: A computer-implemented method, comprising: learning, by a device operatively coupled to a processor, noise associated with a mid-circuit non-unitary operation of a dynamic quantum circuit, by modifying the mid-circuit non-unitary operation with a probabilistic Pauli-Z gate and twirled Pauli operators.

CLAUSE 9: The computer-implemented method of any preceding clause, wherein the mid-circuit non-unitary operation comprises a mid-circuit qubit measurement that feeds forward to at least one classically-controlled quantum gate.

CLAUSE 10: The computer-implemented method of any preceding clause, wherein the at least one classically-controlled quantum gate is between the twirled Pauli operators.

CLAUSE 11: The computer-implemented method of any preceding clause, wherein the at least one classically-controlled quantum gate is not between the twirled Pauli operators.

CLAUSE 12: The computer-implemented method of any preceding clause, wherein the learning the noise comprises: repeatedly executing, by the device and across both a set of Pauli bases and a set of repetition depths, the mid-circuit non-unitary operation as modified with the probabilistic Pauli-Z gate and the twirled Pauli operators; and extracting, by the device and based on such repeated executions, a set of basis fidelities respectively corresponding to the set of Pauli bases.

CLAUSE 13: The computer-implemented method of any preceding clause, wherein the learning the noise comprises: inverting, by the device, the set of basis fidelities via commutation relations defined between the set of Pauli bases and a set of Pauli generators associated with the noise.

CLAUSE 14: The computer-implemented method of any preceding clause, further comprising: mitigating, by the device, the noise by inserting an inverse of the noise into the dynamic quantum circuit.

In various aspects, any combination or combinations of any of clauses 8-14 can be implemented.

CLAUSE 15: A computer program product for facilitating noise learning in dynamic quantum circuits, the computer program product comprising a non-transitory computer-readable memory having program instructions embodied therewith, the program instructions executable by a processor to cause the processor to: learn noise associated with a mid-circuit non-unitary operation of a dynamic quantum circuit, by modifying the mid-circuit non-unitary operation with a probabilistic Pauli-Z gate and twirled Pauli operators.

CLAUSE 16: The computer program product of any preceding clause, wherein the mid-circuit non-unitary operation comprises a mid-circuit qubit measurement that feeds forward to at least one classically-controlled quantum gate.

CLAUSE 17: The computer program product of any preceding clause, wherein the at least one classically-controlled quantum gate is between the twirled Pauli operators.

CLAUSE 18: The computer program product of any preceding clause, wherein the at least one classically-controlled quantum gate is not between the twirled Pauli operators.

CLAUSE 19: The computer program product of any preceding clause, wherein the program instructions are further executable to cause the processor to: repeatedly execute, across a set of Pauli bases and across a set of repetition depths, the mid-circuit non-unitary operation as modified with the probabilistic Pauli-Z gate and the twirled Pauli operators; and extract, based on such repeated executions, a set of basis fidelities respectively corresponding to the set of Pauli bases.

CLAUSE 20: The computer program product of any preceding clause, wherein the program instructions are further executable to cause the processor to: invert the set of basis fidelities via commutation relations defined between the set of Pauli bases and a set of Pauli generators associated with the noise.

In various aspects, any combination or combinations of any of clauses 15-20 can be implemented.

### DESCRIPTION OF THE DRAWINGS

FIG. 1 illustrates a block diagram of an example, non-limiting system that facilitates noise learning in dynamic quantum circuits in accordance with one or more embodiments described herein.

FIG. 2 illustrates an example, non-limiting diagram of a dynamic quantum circuit in accordance with one or more embodiments described herein.

FIG. 3 illustrates a block diagram of an example, non-limiting system including a probabilistic Pauli-Z gate, twirled Pauli operators, and a set of learned noise model coefficients that facilitates noise learning in dynamic quantum circuits in accordance with one or more embodiments described herein.

FIGS. 4-5 illustrate example, non-limiting block diagrams of a mid-circuit non-unitary operation modified with a probabilistic Pauli-Z gate and twirled Pauli operators in accordance with one or more embodiments described herein.

FIG. 6 illustrates an example, non-limiting block diagram showing how noise associated with a mid-circuit non-unitary operation can be composed of noise model Pauli generators and noise model coefficients in accordance with one or more embodiments described herein.

FIG. 7 illustrates an example, non-limiting block diagram showing how an observable expectation value can be obtained with respect to a mid-circuit non-unitary operation in accordance with one or more embodiments described herein.

FIG. 8 illustrates an example, non-limiting block diagram showing how multiple sets of observable expectation valuers can be obtained in accordance with one or more embodiments described herein.

FIG. 9 illustrates an example, non-limiting block diagram showing how basis fidelities can be obtained from multiple sets of observable expectation values in accordance with one or more embodiments described herein.

FIG. 10 illustrates an example, non-limiting block diagram showing how learned noise model coefficients can be obtained from basis fidelities in accordance with one or more embodiments described herein.

FIG. 11 illustrates example, non-limiting experimental results in accordance with one or more embodiments described herein.

FIG. 12 illustrates a block diagram of an example, non-limiting system including an inverted noise operation that facilitates noise learning in dynamic quantum circuits in accordance with one or more embodiments described herein.

FIGS. 13-14 illustrate example, non-limiting block diagrams of a dynamic quantum circuit into which an inverted noise operation is inserted in accordance with one or more embodiments described herein.

FIGS. 15-16 illustrate example, non-limiting experimental results in accordance with one or more embodiments described herein.

FIG. 17 illustrates a flow diagram of an example, non-limiting computer-implemented method that facilitates noise learning in dynamic quantum circuits in accordance with one or more embodiments described herein.

FIG. 18 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computer can be any suitable device that utilizes a qubit lattice (e.g., a plurality of superconducting qubits fabricated on one or more quantum substrates and exhibiting any suitable connection topology) for information processing. A quantum circuit can be a sequence of any suitable number of parallel or series quantum gates that can be executed on a quantum computer. A quantum gate can be a basic component of a quantum circuit that can change, alter, or otherwise affect the state of a qubit. As some non-limiting examples, a quantum gate can be any suitable single-qubit gate (e.g., Pauli-X gates, Pauli-Y gates, Pauli-Z gates, Phase gates, Rotation gates, Hadamard gates) or any suitable entangling or two-qubit gate (e.g., Controlled-Not gates, Controlled-Phase gates).

A regular quantum circuit can be a quantum circuit whose only non-unitary operations are qubit measurements that are located at an end (e.g., in a final layer) of the quantum circuit. That is, a regular quantum circuit can contain no mid-circuit non-unitary operations. In contrast, a dynamic quantum circuit can be a quantum circuit that contains one or more mid-circuit non-unitary operations. As a non-limiting example, a mid-circuit non-unitary operation can include a mid-circuit qubit measurement. In various aspects, a mid-circuit qubit measurement can be a qubit measurement operation that is not pushed to an end of a circuit. In other words, a mid-circuit qubit measurement can be a qubit measurement operation that is performed after at least one first quantum gate of the circuit and before at least one second quantum gate of the circuit. In various cases, a mid-circuit qubit measurement can feed forward to one or more classically-controlled quantum gates. In various aspects, a classically-controlled quantum gate can be any suitable quantum gate whose performance depends upon or is otherwise controlled by a qubit measurement operation (e.g., if the qubit measurement operation yields a measured value of 0, the classically-controlled quantum gate can be not performed; instead, if the qubit measurement operation yields a measured value of 1, the classically-controlled quantum gate can be performed). In various instances, the term “classically-controlled” can be used to refer to such a quantum gate, because a qubit measurement operation collapses the superimposed quantum state of a qubit into a classical bit having only two possible values: 0 or 1.

Dynamic quantum circuits can be considered as more computationally powerful and versatile than regular quantum circuits. Indeed, if a dynamic quantum circuit contains one or more mid-circuit qubit measurements, those one or more mid-circuit qubit measurements can, in some cases, influence in real-time which quantum gates are or are not applied during a remainder of the dynamic quantum circuit. For example, suppose that the dynamic quantum circuit includes a mid-circuit qubit measurement on a first qubit, where such mid-circuit qubit measurement feeds forward to a particular quantum gate on a second qubit. In various cases, if the mid-circuit qubit measurement yields a value of 1, then the particular quantum gate can be applied to the second qubit. However, if the mid-circuit qubit measurement instead yields a value of 0, then the particular quantum gate can be not applied to the second qubit. Such flexibility of dynamic quantum circuits can help to reduce circuit depth or otherwise ameliorate qubit connectivity constraints.

However, implementation of dynamic quantum circuits can be impeded by a dearth of effective error mitigation or suppression techniques. Regardless of being regular or dynamic, quantum circuits can experience noise (e.g., although single qubit quantum gates can be noiseless, entangling quantum gates and qubit measurements are not noiseless). Such noise can degrade circuit performance, which can be undesirable. Error mitigation or suppression techniques can be considered as quantum computing protocols that can help to reduce such noise. Unfortunately, existing error mitigation or suppression techniques, such as probabilistic error cancellation (PEC), are effectively or efficaciously applicable only to regular quantum circuits and not to dynamic quantum circuits. In particular, existing error mitigation techniques assume that all non-unitary operations are pushed to the end of a circuit and thus cannot properly learn or mitigate noise when mid-circuit non-unitary operations are involved. Furthermore, although existing error suppression techniques (e.g., such as intra-circuit pausing or segmentation to allow noise to dissipate) are technically performable on dynamic quantum circuits, such existing error suppression techniques have been empirically found to yield significantly worse-than-expected noise suppression for dynamic quantum circuits than for regular quantum circuits. In other words, existing error mitigation or suppression techniques are either incompatible with or not effectively compatible with mid-circuit non-unitary operations, such as mid-circuit qubit measurements that feed forward to classically controlled quantum gates.

Accordingly, systems or techniques that can address one or more of these technical problems can be desirable.

Various embodiments described herein can address one or more of these technical problems. Specifically, various embodiments described herein can facilitate noise learning in dynamic quantum circuits. That is, the inventors of various embodiments described herein devised various techniques for identifying, determining, measuring, or otherwise learning noise that is caused by mid-circuit non-unitary operations, such as mid-circuit qubit measurements that feed forward to classically controlled quantum gates. In particular, such various techniques can involve modifying a mid-circuit non-unitary operation with a probabilistic Pauli-Z gate and with twirled Pauli operators. In various aspects, implementation of the twirled Pauli operators can be considered as reshaping the noise caused by the mid-circuit non-unitary operation, such that the noise can be considered as a function of multiple Pauli generators corresponding to multiple noise coefficients. In various instances, such various techniques can further include repeatedly executing the mid-circuit non-unitary operation, as modified with the probabilistic Pauli-Z gate and the twirled Pauli operators, across multiple Pauli bases and across multiple repetition depths. In various cases, measurements taken during such repeated executions can yield multiple basis fidelities associated with the multiple Pauli bases. In various aspects, the multiple noise coefficients can be determined by inverting the multiple basis fidelities via commutation relations between the multiple Pauli bases and the multiple Pauli generators. When the multiple noise coefficients are determined, the noise caused by the mid-circuit non-unitary operation can be considered as having been learned. In various instances, such learned noise can be inverted, and such inverted noise can be executed prior to the mid-circuit non-unitary operation, thereby mitigating or otherwise reducing the noise caused by the mid-circuit non-unitary operation. However, this is a mere non-limiting example. In various other instances, such learned noise can be utilized for any suitable purpose, such as benchmarking techniques, designing noise-tailored quantum algorithms or quantum error correction protocols, facilitating real-time device tune-up, or facilitating dynamic decoupling.

Various embodiments described herein can be considered as a computerized tool (e.g., any suitable combination of computer-executable hardware or computer-executable software) that can facilitate noise learning in dynamic quantum circuits. In various aspects, such a computerized tool can comprise an access component, a learning component, or a mitigation component.

In various embodiments, there can be a quantum computer. In various aspects, the quantum computer can comprise any suitable number of qubits. In various instances, such qubits can exhibit any suitable structures, constructions, or architectures (e.g., can be superconducting qubits, spin qubits, or quantum dots).

In various cases, there can be a dynamic quantum circuit. In various aspects, the dynamic quantum circuit can be any suitable quantum circuit that can be executed or otherwise performed on the quantum computer, and which can include a mid-circuit non-unitary operation. As a non-limiting example, the mid-circuit non-unitary operation can be a mid-circuit qubit measurement operation that can feed forward to a subsequent, classically controlled quantum gate of the dynamic quantum circuit.

In various instances, it can be desired to learn or mitigate whatever noise is caused by the mid-circuit non-unitary operation. In various cases, the computerized tool as described herein can learn or mitigate such noise.

In various aspects, the access component of the computerized tool can electronically access, via any suitable wired or wireless electronic connections, the quantum computer. In various instances, the access component can further access or otherwise receive, retrieve, or import from any suitable source the dynamic quantum circuit. For example, the access component can obtain the dynamic quantum circuit from any suitable centralized or decentralized data structure (e.g., graph data structure, relational data structure, hybrid data structure), whether remote from or local to the access component. In any case, the access component can access the quantum computer or the dynamic quantum circuit, such that other components of the computerized tool can electronically interact with (e.g., power-up, power-down, initialize, control) the quantum computer or can electronically interact with (e.g., read, write, edit, copy, manipulate, execute) the dynamic quantum circuit.

In various aspects, the learning component of the computerized tool can electronically learn the noise caused by the mid-circuit non-unitary operation, based on a probabilistic Pauli-Z gate and based on twirled Pauli operators. More specifically, the probabilistic Pauli-Z gate can be a Pauli-Z gate that is executed with 50% probability rather than with 100% probability. Furthermore, the twirled Pauli operators can be random tensor products of Pauli gates. In various instances, the learning component can apply the probabilistic Pauli-Z gate to whichever qubit on which the mid-circuit non-unitary operation is performed, such that the probabilistic Pauli-Z gate follows (e.g., occurs after) the mid-circuit non-unitary operation. In various cases, the learning component can flank both the mid-circuit non-unitary operation and the probabilistic Pauli-Z gate with the twirled Pauli operators.

In various aspects, the probabilistic Pauli-Z gate can be considered as removing, eliminating, or otherwise reducing whatever post-execution phase error might be caused by the mid-circuit non-unitary operation. In various instances, the twirled Pauli operators can be considered as reshaping the noise caused by the mid-circuit non-unitary operation into a Pauli structure (e.g., into a diagonal structure). In various cases, based on such reshaping, the noise caused by the mid-circuit non-unitary operation can be considered as being a function of a set of Pauli generators respectively weighted by a set of coefficients. In various aspects, the values or magnitudes of such coefficients can be initially unknown.

In various instances, the learning component can determine such coefficients, and thus can determine the noise caused by the mid-circuit non-unitary operation. In particular, the learning component can repeatedly execute the mid-circuit non-unitary operation, as modified with the probabilistic Pauli-Z gate and the twirled Pauli operators, across a set of Pauli bases and across a set of progressively increasing repetition depths. In various cases, the learning component can measure an observable expectation value for each basis-depth pair, thereby yielding a set of observable expectation values for each Pauli basis. In various aspects, for each specific Pauli basis, the learning component can fit an exponential decay curve to the set of observable expectation values corresponding to that specific Pauli basis, and such fitted exponential decay curve can yield a basis fidelity corresponding to that specific Pauli basis. In other words, the learning component can obtain a set of basis fidelities respectively corresponding to the set of Pauli bases. In various instances, the learning component can determine, identify, or otherwise estimate values for the unknown coefficients corresponding to the set of Pauli generators, by inverting the set of basis fidelities via commutation relations defined between the set of Pauli bases and the set of Pauli generators. In various cases, the commutation relations can be obtained via application of the symplectic inner product to respective basis-generator pairs. In this way, the learning component can determine the set of coefficients corresponding to the set of Pauli generators, and thus can be considered as having determined the noise caused by the mid-circuit non-unitary operation.

In various aspects, the mitigation component of the computerized tool can mitigate the noise caused by the mid-circuit non-unitary operation. More specifically, because the noise can be considered as being a function of the set of Pauli generators and the set of coefficients, the noise can be considered as a valid quantum gate or quantum operation that can be executed on the quantum computer. Accordingly, the mitigation component can compute an inverse operation of that noise, where the inverse operation is likewise a valid quantum gate or quantum operation that can be executed on the quantum computer. Thus, the mitigation component can insert that inverse operation into the dynamic quantum circuit, prior to the mid-circuit non-unitary operation, and such inverse operation can cause the noise of the mid-circuit non-unitary operation to be cancelled or otherwise reduced.

Accordingly, various embodiments described herein can be considered as a computerized tool that can learn noise caused by or otherwise associated with mid-circuit non-unitary operations of dynamic quantum circuits. Once learned, such noise can be mitigated by inversion. However, this is a mere non-limiting example. In other cases, once learned, such noise can be leveraged for any other suitable purpose (e.g., such noise can be leveraged to create noise-tailored quantum protocols).

Various embodiments described herein can be employed to use hardware or software to solve problems that are highly technical in nature (e.g., to facilitate noise learning in dynamic quantum circuits), that are not abstract and that cannot be performed as a set of mental acts by a human. Further, some of the processes performed can be performed by a specialized computer (e.g., quantum computers comprising tangible qubits that can execute or implement dynamic quantum circuits). In various aspects, some defined tasks associated with various embodiments described herein can include: learning, by a device operatively coupled to a processor, noise associated with a mid-circuit non-unitary operation of a dynamic quantum circuit, by modifying the mid-circuit non-unitary operation with a probabilistic Pauli-Z gate and twirled Pauli operators.

Neither the human mind nor a human with pen and paper can electronically access a dynamic quantum circuit containing a mid-circuit non-unitary operation (e.g., mid-circuit qubit measurement with feedforward) and electronically learn noise caused by that mid-circuit non-unitary operation by applying a probabilistic Pauli-Z gate and twirled Pauli operators to the mid-circuit non-unitary operation. After all, a quantum computer is a specialized piece of computing hardware that utilizes physical qubits (e.g., superconducting qubits, such a transmons) to process information. Physical qubits cannot be implemented by the human mind or by a human with pen and paper. Moreover, a quantum circuit can be a sequence of quantum gates that can be executed on a quantum computer. Neither the human mind, nor a human with pen and paper, can execute quantum gates (e.g., probabilistic Pauli-Z gates, twirled Pauli operators) on physical qubits. Therefore, a computerized tool that can learn noise caused by a mid-circuit non-unitary operation via implementation of a probabilistic Pauli-Z gate and twirled Pauli operators is inherently computerized and cannot be implemented in any sensible, practicable, or reasonable way without computers.

In various instances, one or more embodiments described herein can integrate the herein-described teachings into a practical application. As mentioned above, existing error mitigation or suppression techniques (e.g., PEC) are efficaciously compatible only with regular quantum circuits (e.g., quantum circuits in which all non-unitary operations, such as qubit measurements, have been pushed to circuit ends). Indeed, such existing error mitigation or suppression techniques were specifically designed to learn noised caused by or otherwise associated with unitary operations, such as Clifford layers, and not noise caused by or otherwise associated with non-unitary operations, such as qubit measurements. Indeed, although unitary operations can be noisy, they can nevertheless be considered as reversible and thus as fully preserving quantum information. In stark contrast, non-unitary operations can be considered as irreversible and thus as not fully preserving quantum information. In other words, even if they were noiseless, non-unitary operations can be considered as irreversibly throwing away at least some quantum information. Existing error mitigation or suppression techniques are not able to learn noise amidst such thrown away quantum information. Additionally, noise caused by unitary operations can affect only those qubits on which the unitary operations are performed. That is, noise from unitary operations can propagate at most through directly coupled neighboring qubits. In stark contrast, noise caused by non-unitary operations can affect any or all qubits of a quantum computer. In other words, noise from non-unitary operations can propagate not only through directly coupled neighboring qubits, but also through qubit readout lines or otherwise among non-neighboring qubits. This can render noise from non-unitary operations highly complicated, device-dependent, and difficult to handle. For at least these reasons, existing error mitigation or suppression techniques are not effectively compatible with mid-circuit non-unitary operations.

Various embodiments described herein can address one or more of these technical problems of existing error mitigation or suppression techniques. In other words, various embodiments described herein can enable noise caused by a mid-circuit non-unitary operation to be learned. Indeed, as described herein, the present inventors realized that noise associated with a mid-circuit non-unitary operation can be learned by modifying that mid-circuit non-unitary operation with a probabilistic Pauli-Z gate and with twirled Pauli operators. In particular, such modified mid-circuit non-unitary operation can be iteratively executed across multiple Pauli bases and across multiple iteration depths. In various aspects, basis fidelities can be extracted from measurements taken during such iterative executions, and the noise associated with the mid-circuit non-unitary operation can be identified by inverting those basis fidelities via commutation relations corresponding to the multiple Pauli bases. In this way, the noise caused by the mid-circuit non-unitary operation can be learned, identified, or otherwise determined. In various instances, such learned noise can be leveraged for any suitable purpose. As a non-limiting example, an inverse operation of such learned noise can be computed, and such inverse operation can be inserted or positioned before the mid-circuit non-unitary operation, thereby cancelling, mitigating, or otherwise reducing the noise of the mid-circuit non-unitary operation. In other words, various embodiments described herein can learn or mitigate noise caused by mid-circuit non-unitary operations, in stark contrast to existing error mitigation or suppression techniques which cannot effectively learn or mitigate such noise.

Learning or mitigating noise caused by mid-circuit non-unitary operations can be considered as providing quantifiable performance improvements in the field of quantum circuits. For example, learning or mitigating such noise can enable a quantum computer to achieve meaningful quantum computing results using fewer shots (e.g., by operating less than would otherwise be required). As another example, learning or mitigating such noise can enable more complicated or more sophisticated quantum circuits to be constructed and executed than would otherwise be possible. As yet another example, learning or mitigating such noise can enable quantum computers to operate with less pre-processing or post-processing. In these ways, learning or mitigating noise associated with mid-circuit non-unitary operations can be considered as helping to reduce or make more efficient usage of quantum computing resources. This is a concrete and tangible technical improvement in the field of quantum circuits. For at least these reasons, various embodiments described herein certainly constitute useful and practical applications of computers.

It should be appreciated that the figures and the herein disclosure describe non-limiting examples of various embodiments. It should further be appreciated that the figures are not necessarily drawn to scale.

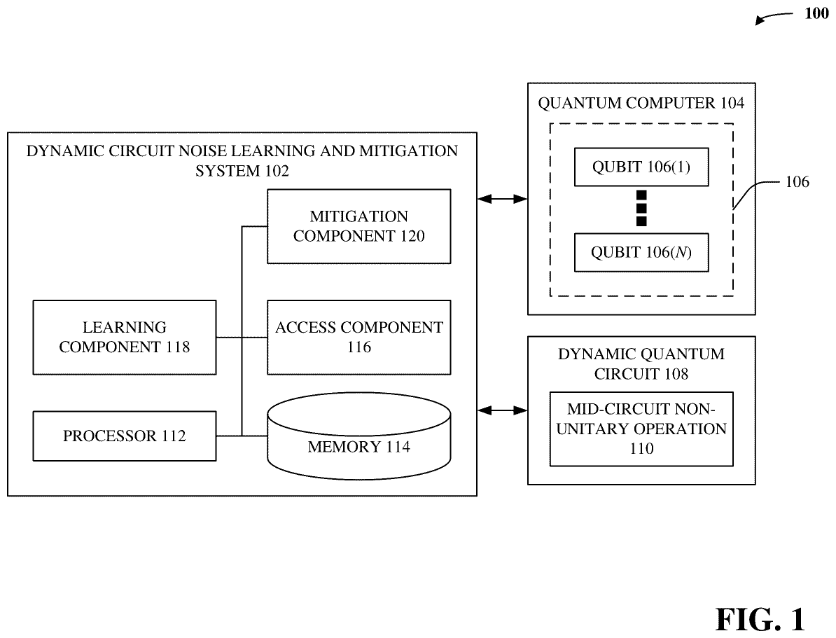

FIG. 1 illustrates a block diagram of an example, non-limiting system 100 that can facilitate noise learning in dynamic quantum circuits in accordance with one or more embodiments described herein. As shown, a dynamic circuit noise learning and mitigation system 102 can be electronically integrated, via any suitable wired or wireless electronic connections, with a quantum computer 104 and with a dynamic quantum circuit 108.

In various embodiments, the quantum computer 104 can be any suitable quantum computing device or quantum computing hardware. In various aspects, the quantum computer 104 can comprise a set of qubits 106. In various instances, the set of qubits 106 can comprise n qubits for any suitable positive integer n: a qubit 106(1) to a qubit 106(n). In various cases, any of the set of qubits 106 can exhibit any suitable structure or architecture. As a non-limiting example, a qubit from the set of qubits 106 can exhibit a superconducting qubit architecture (e.g., such qubit can be constructed from any suitable number of Josephson junctions shunted by any suitable number of planar capacitor pads). As another non-limiting example, a qubit from the set of qubits 106 can exhibit a quantum dot architecture. As yet another non-limiting example, a qubit from the set of qubits 106 can exhibit a spin qubit architecture. In various aspects, different qubits of the set of qubits 106 can exhibit the same or different structures or architectures as each other. In various instances, the set of qubits 106 can exhibit any suitable inter-qubit coupling topology (e.g., rectilinear connection topology, heavy hex connection topology). Although not explicitly shown in FIG. 1, the quantum computer 104 can comprise or otherwise be associated with any suitable hardware or software (e.g., real-time controllers implemented in field programmable gate arrays of the quantum computer 104) that can be used to initialize any of the set of qubits 106 or to perform any suitable quantum operations (e.g., quantum gates, qubit measurements, qubit idling) on the set of qubits 106.

In various aspects, the dynamic quantum circuit 108 can be any suitable sequence of quantum gates or quantum operations that can be executed or otherwise performed on the quantum computer 104. Accordingly, in various instances, the dynamic quantum circuit 108 can be considered as an n-qubit quantum circuit (e.g., can be considered as a quantum circuit that can operate on n qubits). In various cases, the dynamic quantum circuit 108 can comprise a mid-circuit non-unitary operation 110, hence the term “dynamic.” In various aspects, the mid-circuit non-unitary operation 110 can be positioned not at an end of the dynamic quantum circuit 108, hence the term “mid-circuit.” In other words, the mid-circuit non-unitary operation 110 can be located within the dynamic quantum circuit 108 after at least one quantum gate of the dynamic quantum circuit 108 and before at least one other quantum gate of the dynamic quantum circuit 108. In various instances, the mid-circuit non-unitary operation 110 can be any suitable type of quantum computing operation that is non-unitary (e.g., that is irreversible). As a non-limiting example, the mid-circuit non-unitary operation 110 can be a mid-circuit qubit measurement operation. In various cases, such mid-circuit qubit measurement operation can feed forward to any suitable quantum gate of the dynamic quantum circuit 108 that is positioned or located after the mid-circuit non-unitary operation 110.

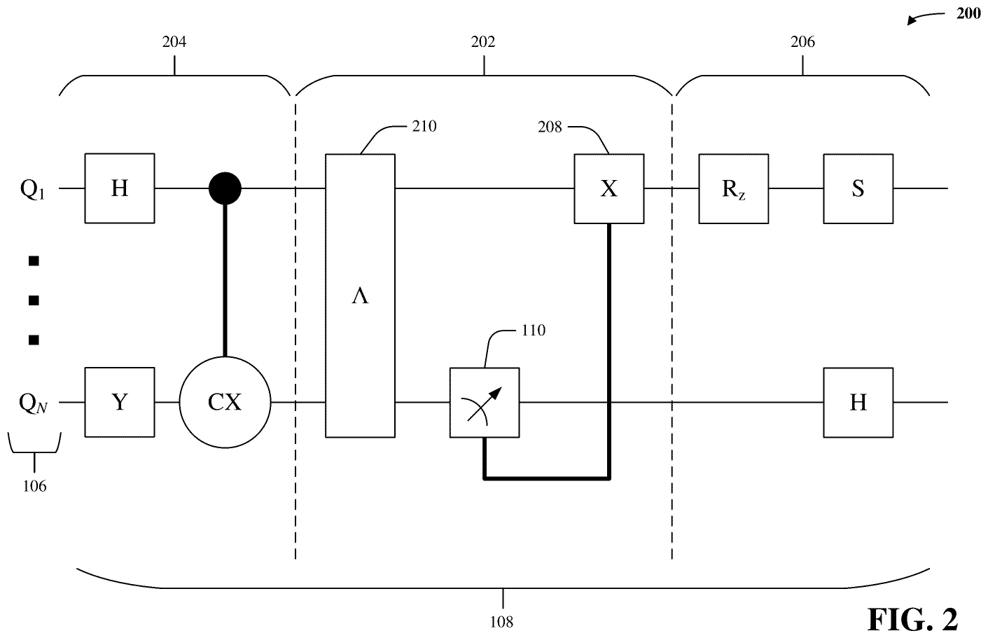

FIG. 2 illustrates an example, non-limiting diagram 200 of the dynamic quantum circuit 108 in accordance with one or more embodiments described herein. That is, FIG. 2 depicts a non-limiting, example embodiment of the dynamic quantum circuit 108 and of the mid-circuit non-unitary operation 110.

As shown, the dynamic quantum circuit 108 can operate on the set of qubits 106 and can thus be considered as being an n-qubit quantum circuit. In various aspects, the dynamic quantum circuit 108 can comprise a mid-circuit non-unitary layer 202, at least one layer 204, and at least one layer 206. In various instances, the mid-circuit non-unitary layer 202 can be whichever layer of the dynamic quantum circuit 108 contains the mid-circuit non-unitary operation 110.

In various cases, the at least one layer 204 can comprise whichever layers of the dynamic quantum circuit 108 that precede the mid-circuit non-unitary layer 202. Accordingly, the at least one layer 204 can comprise any suitable number of any suitable types of quantum gates or quantum operations, and such quantum gates or quantum operations can be considered as preceding (e.g., as being positioned or located before) the mid-circuit non-unitary operation 110. As a non-limiting example, the at least one layer 204 can include a Hadamard gate (denoted by “H”) applied to the qubit 106(1) (denote by “Q₁”), a Pauli-Y gate (denoted by “Y”) applied to the qubit 106(n) (denoted by “Qₙ”), and a controlled Pauli-X gate (denoted by “CX”) having the qubit 106(1) as the source and the qubit 106(n) as the target. Note that these quantum gates are mere non-limiting examples for ease of illustration and explanation. Furthermore, although FIG. 2 does not depict quantum gates in the at least one layer 204 as being applied to any of the set of qubits 106 other than the qubit 106(1) and the qubit 106(n), this is also a mere non-limiting example for ease of illustration and explanation. In various aspects, the at least one layer 204 can comprise any suitable number of any suitable types of quantum gates arranged in any suitable order of execution, and such quantum gates can be applied to any of the set of qubits 106.

In various aspects, the at least one layer 206 can comprise whichever layers of the dynamic quantum circuit 108 that follow the mid-circuit non-unitary layer 202. Accordingly, the at least one layer 206 can comprise any suitable number of any suitable types of quantum gates or quantum operations, and such quantum gates or quantum operations can be considered as following (e.g., as being positioned or located after) the mid-circuit non-unitary operation 110. As a non-limiting example, the at least one layer 206 can include a rotation about the z-axis (denoted by “R,”) applied to the qubit 106(1), a Phase gate (denoted by “S”) applied to the qubit 106(1), and a Hadamard gate applied to the qubit 106(n). Just as above, note that these quantum gates are mere non-limiting examples for ease of illustration and explanation. Additionally, although FIG. 2 does not depict quantum gates in the at least one layer 206 as being applied to any of the set of qubits 106 other than the qubit 106(1) and the qubit 106(n), this is also a mere non-limiting example for ease of illustration and explanation. In various aspects, the at least one layer 206 can comprise any suitable number of any suitable types of quantum gates arranged in any suitable order of execution, and such quantum gates can be applied to any of the set of qubits 106.

In the non-limiting example of FIG. 2, the mid-circuit non-unitary operation 110 can be a mid-circuit qubit measurement that is applied to the qubit 106(n). However, this is a mere non-limiting example for ease of illustration and explanation. In various aspects, the mid-circuit non-unitary operation 110 can be a mid-circuit qubit measurement applied to any other of the set of qubits 106. In various instances, when the mid-circuit non-unitary operation 110 is a mid-circuit qubit measurement, such mid-circuit qubit measurement can feed forward to a classically-controlled quantum gate 208. In other words, whether or not the classically-controlled quantum gate 208 is actually performed can depend upon the result of the mid-circuit qubit measurement. For example, if the mid-circuit qubit measurement yields a measured state of 1, then the classically-controlled quantum gate 208 can be performed. However, if the mid-circuit qubit measurement instead yields a measured state of 0, then the classically-controlled quantum gate 208 can be not performed. In the non-limiting example of FIG. 2, the classically-controlled quantum gate 208 is a Pauli-X gate (denoted by “X”) that is applied to the qubit 106(1). However, this is a mere non-limiting example for ease of illustration and explanation. In various instances, the classically-controlled quantum gate 208 can be any other suitable quantum gate applied to any of the set of qubits 106.

Although FIG. 2 illustrates only a single instance of a mid-circuit non-unitary operation (e.g., 110) being within the mid-circuit non-unitary layer 202, this is a mere non-limiting example for ease of illustration and explanation. In various cases, the mid-circuit non-unitary layer 202 can comprise any suitable number of mid-circuit non-unitary operations, any of which can be applied to any of the set of qubits 106.

In any case, the mid-circuit non-unitary operation 110 can be considered as causing, generating, or otherwise being associated with a noise 210 (denoted by “A”). As shown, the noise 210 can be considered as a quantum operation that potentially affects, corrupts, taints, or otherwise propagates to any or all of the set of qubits 106. In other words, the noise 210 of the mid-circuit non-unitary operation 110 can be not contained only to the particular qubit (e.g., 106(n) in the non-limiting example of FIG. 2) on which the mid-circuit non-unitary operation 110 is performed. In various instances, the noise 210 can be considered as a completely positive trace preserving map (CPTP).

Referring back to FIG. 1, it can be desired to learn, and subsequently mitigate, the noise 210 that is caused by or otherwise associated with the mid-circuit non-unitary operation 110. As described herein, the dynamic circuit noise learning and mitigation system 102 can facilitate such learning and mitigation.

In various embodiments, the dynamic circuit noise learning and mitigation system 102 can comprise a processor 112 (e.g., computer processing unit, microprocessor) and a non-transitory computer-readable memory 114 that is operably connected or coupled to the processor 112. The memory 114 can store computer-executable instructions which, upon execution by the processor 112, can cause the processor 112 or other components of the dynamic circuit noise learning and mitigation system 102 (e.g., access component 116, learning component 118, mitigation component 120) to perform one or more acts. In various embodiments, the memory 114 can store computer-executable components (e.g., access component 116, learning component 118, mitigation component 120), and the processor 112 can execute the computer-executable components.

In various embodiments, the dynamic circuit noise learning and mitigation system 102 can comprise an access component 116. In various aspects, the access component 116 can electronically access, in any suitable fashion, the quantum computer 104, such that the dynamic circuit noise learning and mitigation system 102 can initialize, electronically activate (e.g., power-up), electronically deactivate (e.g., power-down), or otherwise electronically control the quantum computer 104. Furthermore, in various instances, the access component 116 can electronically receive, retrieve, obtain, import, or otherwise access, from any suitable data structures or from any suitable computing devices, the dynamic quantum circuit 108. In any case, the access component 116 can electronically access (e.g., send or receive data or program instructions to or from) the quantum computer 104 or the dynamic quantum circuit 108, such that other components of the dynamic circuit noise learning and mitigation system 102 can electronically interact with the quantum computer 104 or with the dynamic quantum circuit 108.

In various embodiments, the dynamic circuit noise learning and mitigation system 102 can comprise a learning component 118. In various aspects, as described herein, the learning component 118 can learn the noise 210 of the mid-circuit non-unitary operation 110, based on a probabilistic Pauli-Z gate and based on twirled Pauli operators.

In various embodiments, the dynamic circuit noise learning and mitigation system 102 can comprise a mitigation component 120. In various instances, as described herein, the mitigation component 120 can mitigate the noise 210 of the mid-circuit non-unitary operation 110, by inserting an inverse operation of the noise 210 into the dynamic quantum circuit 108.

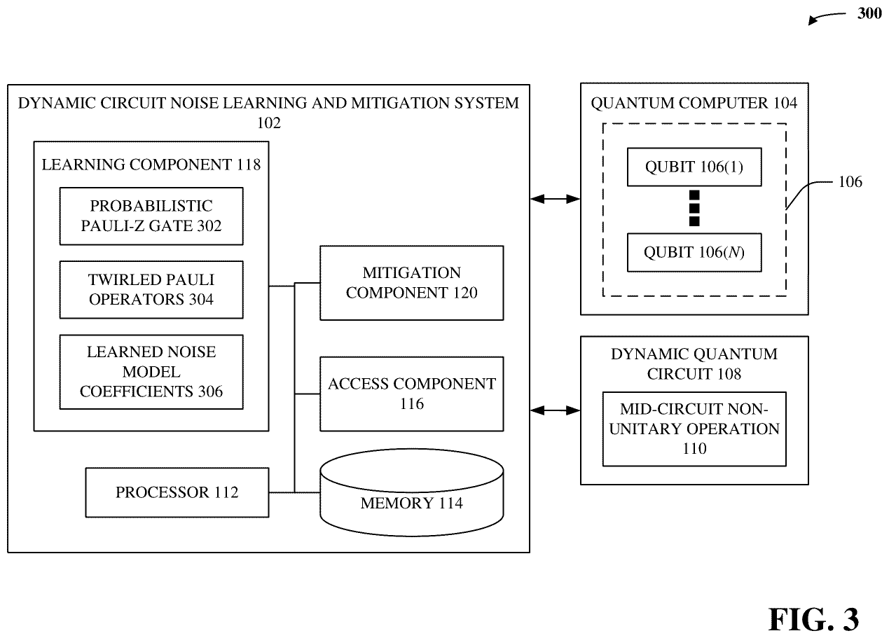

FIG. 3 illustrates a block diagram of an example, non-limiting system 300 including a probabilistic Pauli-Z gate, twirled Pauli operators, and a set of learned noise model coefficients that can facilitate noise learning in dynamic quantum circuits in accordance with one or more embodiments described herein. As shown, the system 300 can, in some cases, comprise the same components as the system 100, and can further comprise a probabilistic Pauli-Z gate 302, a pair of twirled Pauli operators 304, and a set of learned noise model coefficients 306.

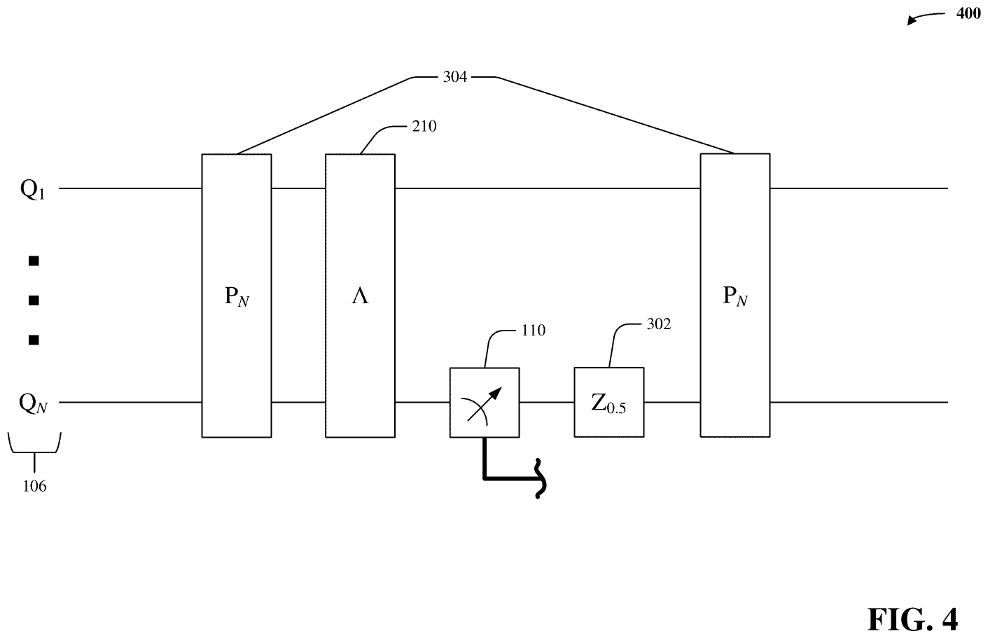

In various aspects, the set of learned noise model coefficients 306 can be considered as a set of scalars that characterize or define the noise 210. In various instances, the learning component 118 can electronically determine, identify, or estimate the set of learned noise model coefficients 306 by using the probabilistic Pauli-Z gate 302 and by using the pair of twirled Pauli operators 304. More specifically, the learning component 118 can electronically modify the mid-circuit non-unitary operation 110 with the probabilistic Pauli-Z gate 302 and with the twirled Pauli operators 304. In various cases, the learning component 118 can repeatedly or iteratively execute the mid-circuit non-unitary operation 110, as modified with the probabilistic Pauli-Z gate 302 and with the pair of twirled Pauli operators 304, on the quantum computer 104 and across both a set of Pauli bases and a set of repetition depths. Based on such repeated or iterative executions, the learning component 118 can measure or extract a set of basis fidelities. In various aspects, the learning component 118 can determine or identify the set of learned noise model coefficients 306 based on the set of basis fidelities. Various non-limiting aspects are further described with respect to FIGS. 4-10.

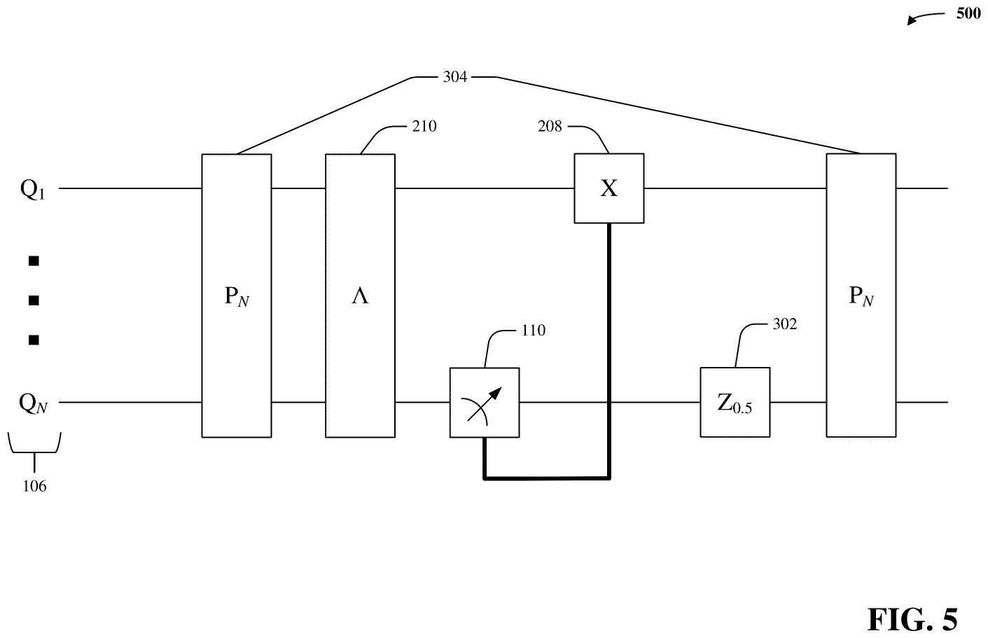

FIGS. 4-5 illustrate example, non-limiting block diagrams of the mid-circuit non-unitary operation 110 being modified with the probabilistic Pauli-Z gate 302 and with the pair of twirled Pauli operators 304 in accordance with one or more embodiments described herein.

First, consider FIG. 4. In various embodiments, as shown, the learning component 118 can generate or create a quantum circuit segment 400 that includes the mid-circuit non-unitary operation 110 (and its associated noise 210) and that excludes the rest of the dynamic quantum circuit 108.

In various aspects, the learning component 118 can, within the quantum circuit segment 400, modify the mid-circuit non-unitary operation 110 with the probabilistic Pauli-Z gate 302 (denoted by “Z_{0.5}”). More specifically, as shown, the learning component 118 can position the probabilistic Pauli-Z gate 302 after the mid-circuit non-unitary operation 110 and on whichever of the set of qubits 106 corresponds to the mid-circuit non-unitary operation 110. In the non-limiting example of FIG. 4, the mid-circuit non-unitary operation 110 is applied to the qubit 106(n). Accordingly, the probabilistic Pauli-Z gate 302 can be applied to the qubit 106(n) after (e.g., downstream of) the mid-circuit non-unitary operation 110. In any case, the probabilistic Pauli-Z gate 302 can be a single-qubit Pauli-Z gate that is applied with 50% probability or 50% likelihood, hence the notation “0.5.” In other words, during execution on a quantum computer (e.g., 104), the probabilistic Pauli-Z gate 302 would have a 50% chance of performing a Pauli-Z operation and a 50% chance of performing no operation. In any case, the mid-circuit non-unitary operation 110 can be considered as having a residual phase error, and the probabilistic Pauli-Z gate 302 can be considered as removing, zeroing out, or otherwise reducing such residual phase error.

In various aspects, the learning component 118 can, within the quantum circuit segment 400, modify the mid-circuit non-unitary operation 110 with the pair of twirled Pauli operators 304. More specifically, the pair of twirled Pauli operators 304 can be an identical pair of n-qubit Paulis (each denoted by “Pₙ”), where one of such pair is applied before (e.g., upstream of) the mid-circuit non-unitary operation 110, and where the other of such pair is applied after (e.g., downstream of) the probabilistic Pauli-Z gate 302. In various instances, the pair of twirled Pauli operators 304 can be selected at random from a set of all possible n-qubit Paulis. In particular, Pₙ∈{I, X, Y, Z}^{⊗n} can be randomly chosen, where/can be the single-qubit identity matrix, where X can be the single-qubit Pauli-X gate, where Y can be the single-qubit Pauli-Y gate, and where Z can be the single-qubit Pauli-Z gate. When Pₙ flanks both the mid-circuit non-unitary operation 110 and the probabilistic Pauli-Z gate 302, the mid-circuit non-unitary operation 110 and the probabilistic Pauli-Z gate 302 can be considered as being twirled by Pₙ, hence the term “twirled Pauli operators.”

As shown in FIG. 4, when the mid-circuit non-unitary operation 110 is a mid-circuit qubit measurement that feeds forward to the classically-controlled quantum gate 208, the classically-controlled quantum gate 208 can be omitted from the quantum circuit segment 400. That is, the classically-controlled quantum gate 208 can, in some embodiments, not be positioned, located, or applied between the pair of twirled Pauli operators 304. However, this is a mere non-limiting example. In other embodiments, the classically-controlled quantum gate 208 can be positioned, located, or applied between the pair of twirled Pauli operators 304. Indeed, this is shown in non-limiting fashion in FIG. 5. In particular, FIG. 5 illustrates a quantum circuit segment 500 that can contain or comprise the same components as the quantum circuit segment 400, and that can further comprise the classically-controlled quantum gate 208. For ease of explanation and illustration, many of the remaining figures depict various non-limiting embodiments with respect to the quantum circuit segment 400. However, it is to be understood and appreciated that such embodiments can analogously be applied to the quantum circuit segment 500.

Moreover, note that, as mentioned above, the figures illustrate one mid-circuit non-unitary operation (e.g., a single instance of 110) being within the mid-circuit non-unitary layer 202 of the dynamic quantum circuit 108. For this reason, that one mid-circuit non-unitary operation is shown within the quantum circuit segment 400 (and the quantum circuit segment 500). However, this is a mere non-limiting example for ease of illustration and explanation. In various embodiments, as mentioned above, the mid-circuit non-unitary layer 202 can comprise multiple mid-circuit non-unitary operations which can be applied to multiple of the set of qubits 106. In such embodiments, the learning component 118 can include within the quantum circuit segment 400 (or 500) all of the mid-circuit non-unitary operations that are within the mid-circuit non-unitary layer 202. Furthermore, in such embodiments, the learning component 118 can modify each of such mid-circuit non-unitary operations with a respective probabilistic Pauli-Z gate (e.g., a respective instance of 302), and all of such mid-circuit non-unitary operations and their respective probabilistic Pauli-Z gates can be collectively flanked by Pₙ (e.g., by the pair of twirled Pauli operators 304). In such embodiments, the noise 210 can be considered as the collective or total noise created or generated by all of such multiple mid-circuit non-unitary operations. For example, suppose that the mid-circuit non-unitary layer 202 includes a mid-circuit non-unitary operations (e.g., a instances of 110, respectively applied to a of the set of qubits 106) for any suitable positive integer a≤n. In such case, the learning component 118 can insert, onto their respective qubits, all a of such mid-circuit non-unitary operations into the quantum circuit segment 400 (or 500) and can apply a distinct probabilistic Pauli-Z gate to each of such a mid-circuit non-unitary operations. This would yield a total of a probabilistic Pauli-Z gates (e.g., a instances of 302) within the quantum circuit segment 400 (or 500). Moreover, in such case, the pair of twirled Pauli operators 304 can be considered as collectively twirling or flanking all a of such mid-circuit non-unitary operations and all a of such probabilistic Pauli-Z gates. In such cases, the noise 210 can be considered as the collective or total noise generated by all a of the mid-circuit non-unitary operations.

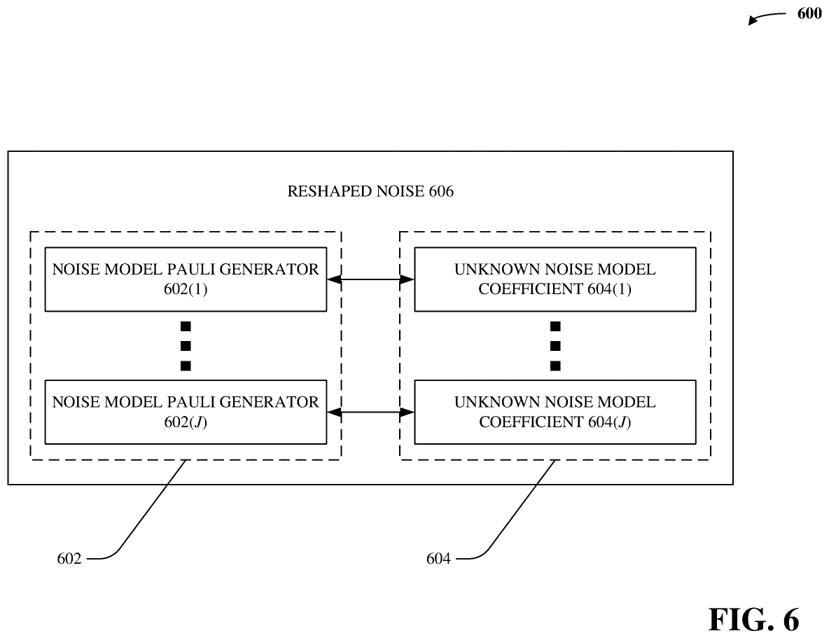

In any case, flanking the mid-circuit non-unitary operation 110 with the pair of twirled Pauli operators 304 can be considered as reshaping or reformatting the noise 210 into a Pauli or diagonal structure. More specifically, such twirling can cause the noise 210 to be expressible or definable in terms of a set of Pauli generators and a set of coefficients respectively corresponding to those Pauli generators. Various non-limiting aspects are further described with respect to FIG. 6.

FIG. 6 illustrates an example, non-limiting block diagram 600 showing how the noise 210, after having been reshaped by the pair of twirled Pauli operators 304, can be considered as being composed of noise model Pauli generators and noise model coefficients in accordance with one or more embodiments described herein.

For ease of explanation, the noise 210 can, after having been reshaped or reformatted by the pair of twirled Pauli operators 304, be referred to as reshaped noise 606. In various embodiments, the reshaped noise 606 can be considered as being defined by or otherwise being a function of a set of noise model Pauli generators 602 and a set of unknown noise model coefficients 604. In various aspects, the set of noise model Pauli generators 602 can comprise j generators for any suitable positive integer j: a noise model Pauli generator 602(1) to a noise model Pauli generator 602(j). In various instances, each of the set of noise model Pauli generators 602 can be a unique or distinct n-qubit Pauli operator that is not the n-qubit identity matrix. For example, the noise model Pauli generator 602(1) can be a member of {I, X, Y, Z}^{⊗n}\/I^{⊗n}, and the noise model Pauli generator 602(1) can be a different member of {I, X, Y, Z}^{⊗n}\/I^{⊗n}. Because the set of all possible n-qubit Pauli operators minus the n-qubit identity matrix can have a cardinality of 4ⁿ−1, it can be the case that j≤4ⁿ−1. Furthermore, in some cases, sparsity can be inferred, applied, or otherwise enforced, in which case j<4ⁿ−1. Indeed, because the probabilistic Pauli-Z gate 302 can be considered as zeroing out residual phase error associated with the mid-circuit non-unitary operation 110, the set of noise model Pauli generators 602 can omit or otherwise exclude any n-qubit Pauli operator that has either a Pauli-Y noise or a Pauli-Z noise applied to the qubit corresponding to the mid-circuit non-unitary operation 110 (e.g., applied to the qubit 106(n) in the non-limiting examples shown in the figures).

As a non-limiting example, suppose that n=2, and suppose that the mid-circuit non-unitary operation 110 is applied to the qubit 2 and not to the qubit 1. In various aspects, the total set of possible 2-qubit Pauli operators can be a 16-element set given by:

$$\{ I ⊗ I , I ⊗ X , I ⊗ Y , I ⊗ Z , X ⊗ I , X ⊗ X , X ⊗ Y , X ⊗ Z , Y ⊗ I , Y ⊗ X , Y ⊗ Y , Y ⊗ Z , Z ⊗ I , Z ⊗ X , Z ⊗ Y , Z ⊗ Z \}$$

In various aspects, the 2-qubit identity operator can be omitted, which can yield a 15-element set given by:

$$\{ I ⊗ X , I ⊗ Y , I ⊗ Z , X ⊗ I , X ⊗ X , X ⊗ Y , X ⊗ Z , Y ⊗ I , Y ⊗ X , Y ⊗ Y , Y ⊗ Z , Z ⊗ I , Z ⊗ X , Z ⊗ Y , Z ⊗ Z \}$$

In some cases, the set of noise model Pauli generators 602 can be equivalent to such 15-element set.

Now, due to implementation of the probabilistic Pauli-Z gate 302, any 2-qubit Pauli operator associated with Pauli-Y noise or Pauli-Z noise on the qubit 2 can be omitted from such 15-element set, which can yield a 7-element set given by:

$$\{ I ⊗ X , X ⊗ I , X ⊗ X , Y ⊗ I , Y ⊗ X , Z ⊗ I , Z ⊗ X \}$$

Accordingly, the set of noise model Pauli generators 602 can, in such embodiments, be equivalent to such 7-element set. The reduction from 15 elements to 7 elements can be considered as a significant improvement in sparsity which can help to reduce computational complexity in learning the noise 210.

As another non-limiting example, suppose that n>2. In such case, one may keep only low-weight noise model Pauli generators to reduce complexity as qubit number increases, where weight of an n-qubit Pauli is the number of non-identity single-qubit Pauli operations in that n-qubit Pauli. In particular, suppose n=5, where the mid-circuit non-unitary operation 110 is a qubit measurement applied to qubit 5 and not to qubits 1-4. Note that the set of all possible 5-qubit Pauli operators has a cardinality of 1024. This cardinality can be reduced to 1023 by excluding the 5-qubit identity operator. Additionally, due to implementation of the probabilistic Pauli-Z gate 302, this cardinality can be further reduced from 1023 to 511, because any noise model Pauli generator associated with a Pauli-Y noise or a Pauli-Z noise on the qubit 5 can be omitted. Additionally, keeping at most only weight-2 Pauli operators on the unmeasured qubits (e.g., qubits 1-4 in this example) can allow terms of the form X⊗Y⊗Y⊗Z⊗X to be omitted and terms of the form X⊗X⊗I⊗I⊗X or I⊗X⊗I⊗I⊗X to be retained. This can further reduce the cardinality from 511 to 133. In various cases, the set of noise model Pauli generators 602 can be equivalent to such 133—element set.

In various aspects, the set of unknown noise model coefficients 604 can respectively correspond to the set of noise model Pauli generators 602. Accordingly, since the set of noise model Pauli generators 602 can comprise j generators, the set of unknown noise model coefficients 604 can comprise j coefficients: an unknown noise model coefficient 604(1) to an unknown noise model coefficient 604(j). In various instances, each of the set of unknown noise model coefficients 604 can be a real-valued, non-negative scalar having a currently unknown magnitude and corresponding to a respective one of the set of noise model Pauli generators 602. As a non-limiting example, the unknown noise model coefficient 604(1) can be a real-valued, non-negative scalar whose magnitude is not yet known and that corresponds to the noise model Pauli generator 602(1). Likewise, the unknown noise model coefficient 604(j) can be a real-valued, non-negative scalar whose magnitude is not yet known and that corresponds to the noise model Pauli generator 602(j).

In various aspects, as mentioned above, the reshaped noise 606 (e.g., the noise 210 after being reformatted or reshaped by the pair of twirled Pauli operators 304) can be expressed or defined in terms of the set of noise model Pauli generators 602 and of the set of unknown noise model coefficients 604. In particular, implementation of the Lindblad Master equation can yield the following:

$$Λ ( ρ ) = {\prod }_{g ∈ G} ( {w}_{g} \cdot + ( 1 - {w}_{g} ) {P}_{g} \cdot {P}_{g}^{†} ) ρ$$

where w_{g}=2⁻¹(1+e^{-2λg}), where Λ can be the reshaped noise 606 (e.g., can be the noise 210 after reshaping via Pauli twirling), where ρ can be an input quantum state (or density matrix), where · can represent a composition of individual noise channels applied to ρ, where G can be an index set corresponding to the set of noise model Pauli generators 602 and to the set of unknown noise model coefficients 604, where P_{g} can be a member of the set of noise model Pauli generators 602, and where λ_{g} can be whatever member of the set of unknown noise model coefficients 604 corresponds to P_{g}. Accordingly, the reshaped noise 606 (e.g., the noise 210 after reshaping by the pair of twirled Pauli operators 304) can be determined, identified, or otherwise learned by determining, identifying, or otherwise learning the set of unknown noise model coefficients 604. In various instances, the learned values or learned magnitudes of the set of unknown noise model coefficients 604 can be considered as the set of learned noise model coefficients 306.

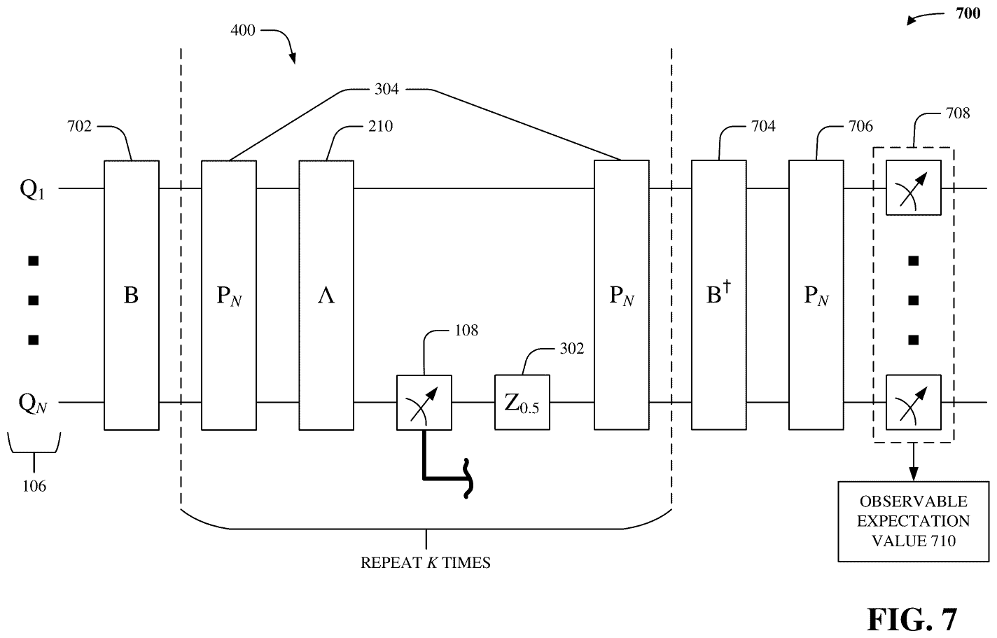

In various embodiments, the learning component 118 can determine or otherwise identify the set of learned noise model coefficients 306 by repeatedly executing the quantum circuit segment 400 (or 500) on the quantum computer 104, across a set of Pauli bases and across a set of repetition depths. Based on such repeated executions, the learning component 118 can measure or extract a set of basis fidelities that respectively correspond to the set of Pauli bases. In various instances, the learning component 118 can invert the set of basis fidelities via commutation relations, thereby yielding the set of learned noise model coefficients 306. Various non-limiting aspects are further described with respect to FIGS. 7-10.

FIG. 7 illustrates an example, non-limiting block diagram 700 showing how an observable expectation value can be obtained with respect to a mid-circuit non-unitary operation in accordance with one or more embodiments described herein. In other words, FIG. 7 shows an example, non-limiting depiction regarding how the learning component 118 can repeatedly execute the quantum circuit segment 400 (or 500).

In various embodiments, the learning component 118 can initialize the set of qubits 106 into any suitable initial quantum states. As a non-limiting example, the learning component 118 can initialize the set of qubits 106 into zero states (e.g., the learning component 118 can cause each of the set of qubits 106 to enter the |0) state).

In various aspects, the learning component 118 can perform or otherwise execute a Pauli basis 702 (denoted by “B”) on the quantum computer 104. In various instances, the Pauli basis 702 can be any suitable n-qubit Pauli operator that is not the n-qubit identity matrix. That is, B∈{I, X, Y, Z}^{⊗n}\/I^{⊗n}.

After performance or execution of the Pauli basis 702, the learning component 118 can, as shown, repeatedly perform or execute the quantum circuit segment 400 (or 500) k times, for any suitable positive integer k. In other words, the learning component 118 can perform or execute the quantum circuit segment 400 (or 500) to a repetition depth of k. Following such repeated performance or execution of the quantum circuit segment 400 (or 500), the learning component 118 can perform or execute the conjugate transpose of the Pauli basis 702, as shown by numeral 704. After performance or execution of the conjugate transpose of the Pauli basis 702, the learning component 118 can perform or execute one of the pair of twirled Pauli operators 304, as shown by numeral 706. In various aspects, the learning component 118 can then measure the resulting quantum states of the set of qubits 106, as shown by numeral 708. In various instances, such measurements can collectively be considered as yielding an observable expectation value 710. In various cases, the observable expectation value 710 can be a scalar that can be considered as a function of the Pauli basis 702 and of the repetition depth k.

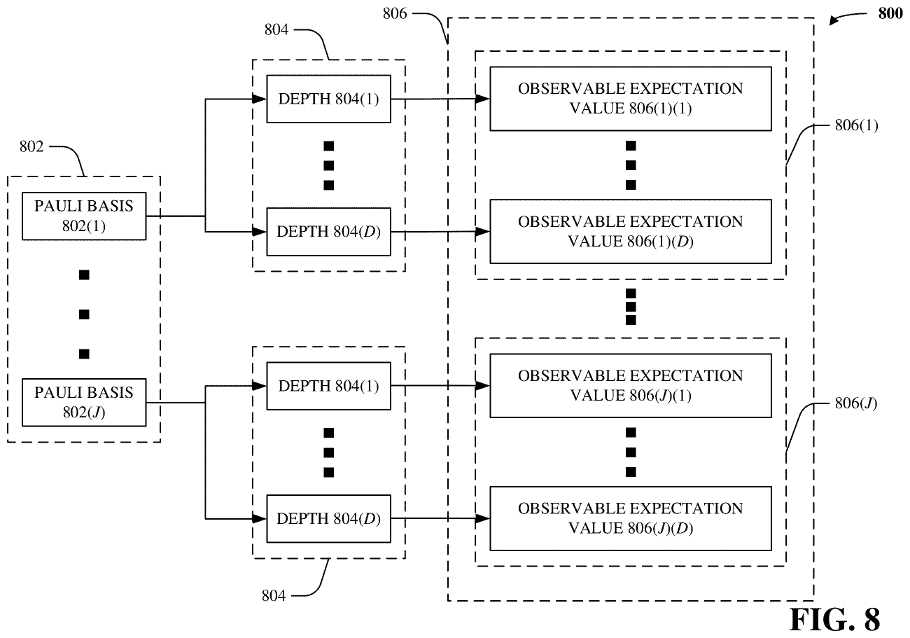

FIG. 8 illustrates an example, non-limiting block diagram 800 showing how multiple sets of observable expectation valuers can be obtained in accordance with one or more embodiments described herein. As mentioned above, the observable expectation value 710 can be considered as being a function of the Pauli basis 702 and of the repetition depth k. Accordingly, the learning component 118 can perform the protocol shown in FIG. 7 across multiple Pauli bases and across multiple repetition depths, thereby yielding multiple observable expectation values.

In particular, there can be a set of Pauli bases 802. In various aspects, the set of Pauli bases 802 can have the same cardinality as the set of noise model Pauli generators 602. Thus, since the set of noise model Pauli generators 602 can comprise j generators, the set of Pauli bases 802 can comprise j bases: a Pauli basis 802(1) to a Pauli basis 802(j). In various aspects, each of the set of Pauli bases 802 can be a unique or distinct member of the set of n-qubit Pauli operators minus the n-qubit identity matrix. As a non-limiting example, the Pauli basis 802(1) can be a member of {I, X, Y, Z}^{⊗n}\/I^{⊗n}, and the Pauli basis 802(j) can be a different member of {I, X, Y, Z}^{⊗n}\I^{⊗n}.

In some cases (e.g., such as when sparsity is not inferred, implemented, or otherwise enforced), both the set of Pauli bases 802 and the set of noise model Pauli generators 602 can be equivalent to {, X, Y, Z}^{⊗n}\I^{⊗n}. However, this is a mere non-limiting example. In other cases (e.g., when sparsity is inferred, implemented, or enforced), the set of Pauli bases 802 can be a strict subset of {I, X, Y, Z}^{⊗n}\I^{⊗n}, and the set of noise model Pauli generators 602 can be a distinct (although possibly overlapping) strict subset of {I, X, Y, Z}^{⊗n}\I^{⊗n}. In such case, the set of Pauli bases 802 can be considered as not being equivalent to the set of noise model Pauli generators 602.

As a non-limiting example, suppose again that n=2. Now, suppose that sparsity is not enforced. In such case, both the set of Pauli bases 802 and the set of noise model Pauli generators 602 can be equivalent to the 15-element set given by:

$$\{ I ⊗ X , I ⊗ Y , I ⊗ Z , X ⊗ I , X ⊗ X , X ⊗ Y , X ⊗ Z , Y ⊗ I , Y ⊗ X , Y ⊗ Y , Y ⊗ Z , Z ⊗ I , Z ⊗ X , Z ⊗ Y , Z ⊗ Z \}$$

However, suppose instead that sparsity is enforced (e.g., due to the cancellation of residual phase error by the probabilistic Pauli-Z gate 302). In such case, the set of noise model Pauli generators 602 can be equivalent to the 7-element set given by:

$$\{ I ⊗ X , X ⊗ I , X ⊗ X , Y ⊗ I , Y ⊗ X , Z ⊗ I , Z ⊗ X \} ,$$

and the set of Pauli bases 802 can instead be equivalent to the 7-element set given by:

$$\{ X ⊗ I , X ⊗ Z , Y ⊗ I , Y ⊗ Z , I ⊗ Z , Z ⊗ I , Z ⊗ Z \} .$$

In such case, the set of Pauli bases 802 and the set of noise model Pauli generators 602 can be considered as having the same cardinality as each other, but they can nevertheless be considered as not equivalent to each other.

Moreover, in various aspects, there can be a set of repetition depths 804. In various instances, the set of repetition depths 804 can comprise d depths for any suitable positive integer d: a depth 804(1) to a depth 804(d). In various cases, each of the set of repetition depths 804 can be considered as a positive integer value that can be assigned to k. In various aspects, the set of repetition depths 804 can progressively increase. In other words, each repetition depth in the set of repetition depths 804 can be larger in value or magnitude than the repetition that came before it (e.g., a depth 804(2) (not shown) can be larger than the depth 804(1), a depth 804(3) (not shown) can be larger than the depth 804(2), . . . , the depth 804(d) can be larger than a depth 804(d−1) (not shown)).

In various aspects, the learning component 118 can perform the protocol shown in FIG. 7 across the set of Pauli bases 802 and across the set of repetition depths 804. In other words, the learning component 118 can perform the protocol shown in FIG. 7 for each unique basis-depth pair. In various instances, this can yield a plurality of sets of observable expectation values 806.

As a non-limiting example, the learning component 118 can select the Pauli basis 802(1) as B and can select the depth 804(1) as k. With such selection, the learning component 118 can perform the protocol shown in FIG. 7, which can yield an observable expectation value 806(1)(1). As another non-limiting example, the learning component 118 can select the Pauli basis 802(1) as B and can select the depth 804(d) as k. With such selection, the learning component 118 can perform the protocol shown in FIG. 7, which can yield an observable expectation value 806(1)(d). In various cases, the observable expectation value 806(1)(1) to the observable expectation value 806(1)(d) can collectively be considered as forming a set of observable expectation values 806(1) that correspond to the Pauli basis 802(1).

As yet another non-limiting example, the learning component 118 can select the Pauli basis 802(j) as B and can select the depth 804(1) as k. With such selection, the learning component 118 can perform the protocol shown in FIG. 7, which can yield an observable expectation value 806(j)(1). As still another non-limiting example, the learning component 118 can select the Pauli basis 802(j) as B and can select the depth 804(d) as k. With such selection, the learning component 118 can perform the protocol shown in FIG. 7, which can yield an observable expectation value 806(j)(d). In various cases, the observable expectation value 806(j)(1) to the observable expectation value 806(j)(d) can collectively be considered as forming a set of observable expectation values 806(j) that correspond to the Pauli basis 802(j).

In various aspects, the set of observable expectation values 806(1) to the set of observable expectation values 806(j) can be considered as collectively forming the plurality of sets of observable expectation values 806.

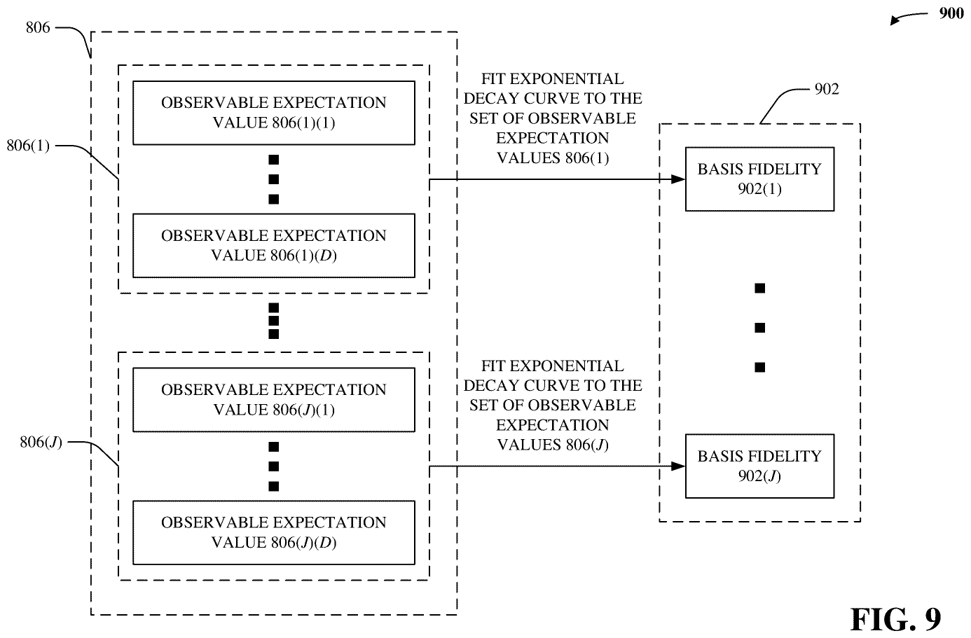

FIG. 9 illustrates an example, non-limiting block diagram 900 showing how basis fidelities can be obtained from multiple sets of observable expectation values in accordance with one or more embodiments described herein.

In various embodiments, the learning component 118 can determine, identify, or otherwise extract a set of basis fidelities 902 based on the plurality of sets of observable expectation values 806. In various aspects, the learning component 118 can accomplish this by fitting exponential decay curves to the plurality of sets of observable expectation values 806.

As a non-limiting example, the learning component 118 can fit an exponential decay curve to the set of observable expectation values 806(1). In various instances, such exponential decay curve can be of the form Af_{B}^{k}, where k can be from the set of repetition depths 804, where B can be the Pauli basis 802(1), where A can be considered as a state preparation and measurement error, and where f_{B} can be a fidelity (e.g., a real-valued scalar ranging from 0 to 1) corresponding to the Pauli basis 802(1). In other words, k can be considered as an independent variable of such exponential decay curve, and A and f_{B} can be considered as constants of such exponential decay curve. By fitting (e.g., via least sum of squares or any other suitable fitting technique) the exponential decay curve to the set of observable expectation values 806(1), f_{B} can be estimated or approximated. Such estimated or approximated value can be considered or otherwise referred to as a basis fidelity 902(1). Note that the basis fidelity 902(1) can be considered as corresponding to the Pauli basis 802(1).

As another non-limiting example, the learning component 118 can fit an exponential decay curve to the set of observable expectation values 806(j). Just as above, in various instances, such exponential decay curve can be of the form Af_{B}^{k}, where k can be from the set of repetition depths 804, where B can be the Pauli basis 802(j), where A can be considered as a state preparation and measurement error, and where f_{B} can be a fidelity (e.g., a real-valued scalar ranging from 0 to 1) corresponding to the Pauli basis 802(j). In other words, k can be considered as an independent variable of such exponential decay curve, and A and f_{B} can be considered as constants of such exponential decay curve. By fitting the exponential decay curve to the set of observable expectation values 806(j), f_{B} can be estimated or approximated. Such estimated or approximated value can be considered or otherwise referred to as a basis fidelity 902(j). Note that the basis fidelity 902(j) can be considered as corresponding to the Pauli basis 802(j).

In various aspects, the basis fidelity 902(1) to the basis fidelity 902(j) can be collectively considered as a set of basis fidelities 902.

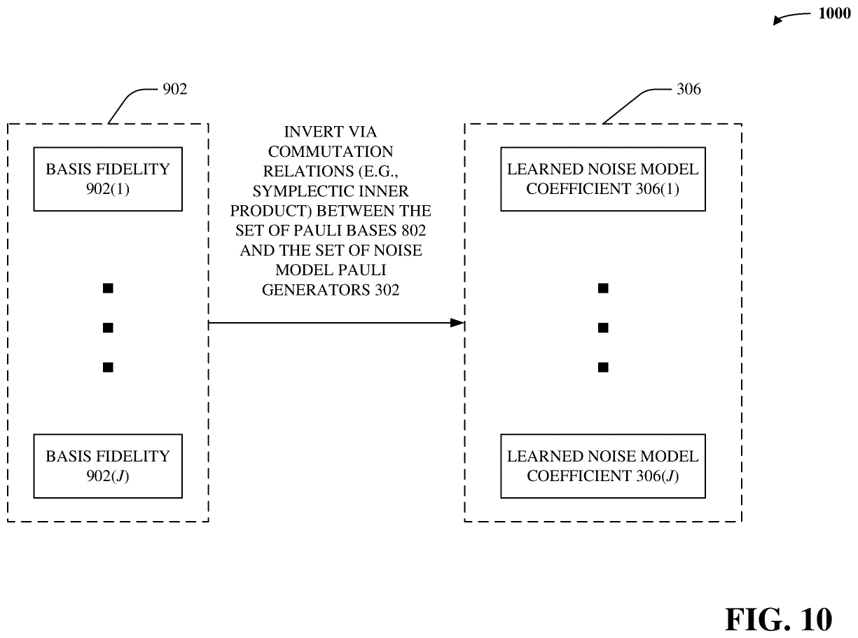

FIG. 10 illustrates an example, non-limiting block diagram 1000 showing how learned noise coefficients can be obtained from basis fidelities in accordance with one or more embodiments described herein.

In various embodiments, the learning component 118 can compute, determine, estimate, or otherwise learn the set of learned noise model coefficients 306, based on the set of basis fidelities 902. In particular, the learning component 118 can invert the set of basis fidelities 902, via commutation relations that can be defined between the set of Pauli bases 802 and the set of noise model Pauli generators 602. More specifically, the learning component 118 can utilize the following formulation:

$$- \frac{log ( \vec{f} )}{2} = M \vec{λ}$$

where \vec{f} can be a column vector representing the set of basis fidelities 902 (which can be indexed according to the set of Pauli bases 802), where \vec{λ} can be a column vector representing the set of unknown noise model coefficients 604 (which can be indexed according to the set of noise model Pauli generators 602), and where M can a square matrix summarizing commutation relations defined between the set of Pauli bases 802 and the set of noise model Pauli generators 602. In various aspects, the rows of M can be indexed according to the set of Pauli bases 802, and the columns of M can be indexed according to the set of noise model Pauli generators 602. In some cases, M can be considered as an application of the symplectic inner product between the set of Pauli bases 802 and the set of noise model Pauli generators 602, as shown by:

M_{r,c}=<Bᵣ,P_{c}>

where M_{r,c} can be element of M that is in the r-th row and the c-th column of M for any suitable positive integers r≤j and c≤j, where Bᵣ can be the r-th Pauli basis in the set of Pauli bases 802, where P_{c} can be the c-th noise model Pauli generator in the set of noise model Pauli generators 602, and where <Bᵣ, P_{c}> can be the symplectic inner product between the Pauli operators Bᵣ and P_{c}. In various cases, <Bᵣ, P_{c}>=1 if {Bᵣ, P_{c}}=0, where {Bᵣ, P_{c}} is the anticommutator of Bᵣ and P_{c}. In various aspects, <Bᵣ, P_{c}>=0 if [Bᵣ, P_{c}]=0, where [Bᵣ, P_{c}] is the commutator of Bᵣ and P_{c}.

In various aspects, the learning component 118 can solve the above formulation for \vec{λ}, by inverting M and applying, via matrix multiplication, such inverse to the left of each side of the above formulation. In particular, such inversion of M can cause the learning component 118 to obtain, determine, or otherwise identify a total of j coefficients: a learned noise model coefficient 306(1) to a learned noise model coefficient 306(j). In various cases, the learned noise model coefficient 306(1) to the learned noise model coefficient 306(j) can collectively be considered as the set of learned noise model coefficients 306. In various aspects, the learned noise model coefficient 306(1) can be considered as the obtained, determined, or identified value or magnitude of the unknown noise model coefficient 604(1). Accordingly, the learned noise model coefficient 306(1) can be considered as corresponding to the noise model Pauli generator 602(1). Similarly, the learned noise model coefficient 306(j) can be considered as the obtained, determined, or identified value or magnitude of the unknown noise model coefficient 604(j). So, the learned noise model coefficient 306(j) can be considered as corresponding to the noise model Pauli generator 602(j).

Thus far, various embodiments have been described in which the set of Pauli bases 802 has the same cardinality (e.g., j) as the set of noise model Pauli generators 602. However, this is a mere non-limiting example for ease of illustration and explanation. In various other embodiments, the set of Pauli bases 802 can have a different cardinality (e.g., can have a different number of elements) than the set of noise model Pauli generators 602. Indeed, the above formulation can be solved for I whenever M has full column rank (e.g., whenever M has at least as many rows as columns). Thus, in various embodiments, the set of Pauli generators 802 can have a larger cardinality than the set of noise model Pauli generators 602 (e.g., the set of Pauli bases 802 can have more than j elements), and a unique I can nevertheless be obtained in such cases. In other words, various embodiments can involve the set of noise model Pauli generators 602 having a cardinality of j and the set of Pauli bases 802 having a cardinality of/for any suitable positive integer l≥j.

In any case, the learning component 118 can determine the set of learned noise model coefficients 306, and thus can be considered as having learned the reshaped noise 606 (e.g., as having learned the reshaped or twirled version of the noise 210).

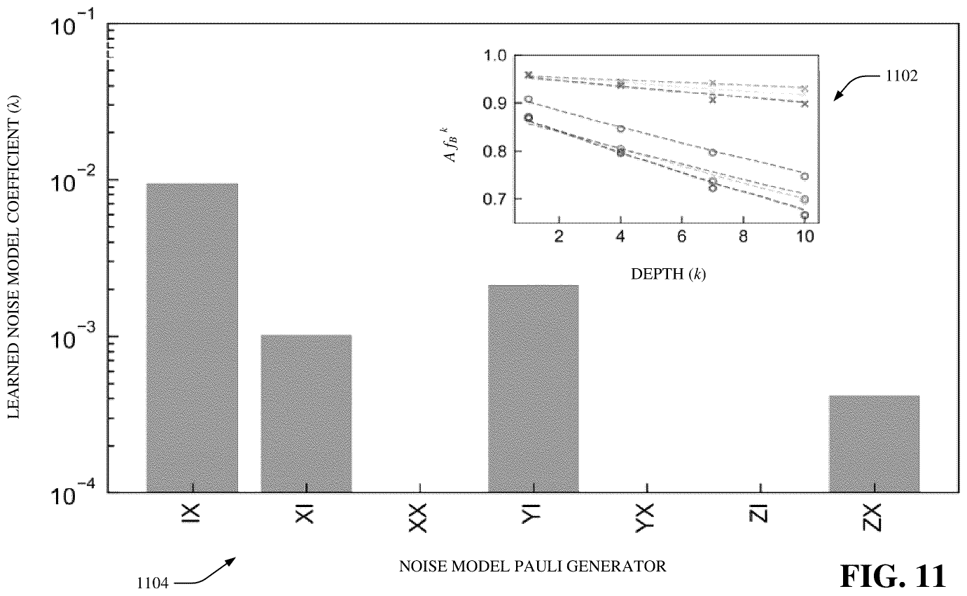

FIG. 11 illustrates example, non-limiting experimental results in accordance with one or more embodiments described herein. In particular, the present inventors performed various experiments in which various embodiments described herein were reduced to practice. During such experiments, the following parameters were implemented: n=2; the mid-circuit non-unitary operation 110 was a mid-circuit qubit measurement on a first qubit; the classically-controlled quantum gate 208 was performed on a second qubit that was not directly coupled to the first qubit; the set of noise model Pauli generators 602 was the 7-element set given by

$$\{ I ⊗ X , X ⊗ I , X ⊗ X , Y ⊗ I , Y ⊗ X , Z ⊗ I , Z ⊗ X \} ;$$

and the set of Pauli bases 802 was the 7-element set given by

$$\{ X ⊗ I , X ⊗ Z , Y ⊗ I , Y ⊗ Z , I ⊗ Z , Z ⊗ I , Z ⊗ Z \} .$$

As shown, FIG. 11 includes a graph 1102 and a graph 1104. The graph 1102 shows exponential decay curves fitted to observable expectation values across repetition depth and across the above-mentioned seven Pauli bases. In particular, the abscissa of the graph 1102 can be considered as ranging across repetition depth, and the different dotted lines in the graph 1102 can be considered as representing different Pauli bases. Based on such fitted exponential decay curves, a distinct basis fidelity was obtained for each of the seven Pauli bases that were utilized: a first basis fidelity for X⊗I, a second basis fidelity for X⊗Z, a third basis fidelity for Y⊗, a fourth basis fidelity for Y⊗Z, a fifth basis fidelity for I⊗Z, a sixth basis fidelity for Z⊗I, and a seventh basis fidelity for Z⊗Z. Moreover, based on such seven basis fidelities, a distinct learned noise model coefficient was obtained for each of the seven noise model Pauli generators. Such distinct learned noise model coefficients are shown in the graph 1104.

Note that, as shown in the graph 1104, a non-zero learned noise model coefficient was obtained for the Z⊗X noise model Pauli generator. This can be considered as correlated noise between the first qubit and the second qubit. However, recall that the first qubit and the second qubit were not directly coupled to each other during this experiment. In the absence of mid-circuit non-unitary operations, such correlated noise between uncoupled qubits would not occur. After all, noise from unitary operations only affects the qubits to which such unitary operations are applied. However, as mentioned above, noise from non-unitary operations can propagate throughout a quantum computer so as to affect qubits that are not directly coupled. Unlike various embodiments described herein, existing error mitigation or suppression techniques are not capable of detecting such correlated noise between uncoupled qubits.

Note that, in some cases, the seven Pauli bases can be measured directly. However, in other cases, fewer than all seven of such Pauli bases can be measured directly, and the remaining Pauli bases can be obtained via post-processing. As a non-limiting example, the X⊗I basis can be measured directly, or the X⊗Z basis can be measured directly and can be post-processed with Z⊗I in order to effectively measure the X⊗I basis. As another non-limiting example, the Y⊗I basis can be measured directly, or the Y⊗Z basis can be measured directly and can be post-processed with Z⊗I in order to effectively measure the Y⊗I basis. Such post-processing can be implemented to help reduce the number of Pauli bases in which direct measurement is implemented.

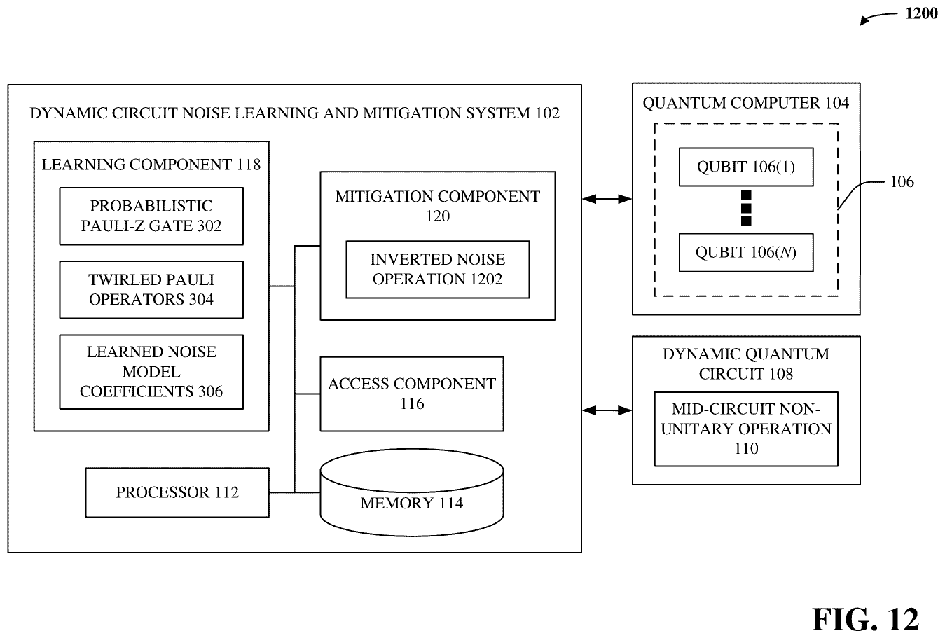

FIG. 12 illustrates a block diagram of an example, non-limiting system 1200 including an inverted noise operation that can facilitate noise learning in dynamic quantum circuits in accordance with one or more embodiments described herein. As shown, the system 1200 can, in some cases, comprise the same components as the system 300, and can further comprise an inverted noise operation 1202.

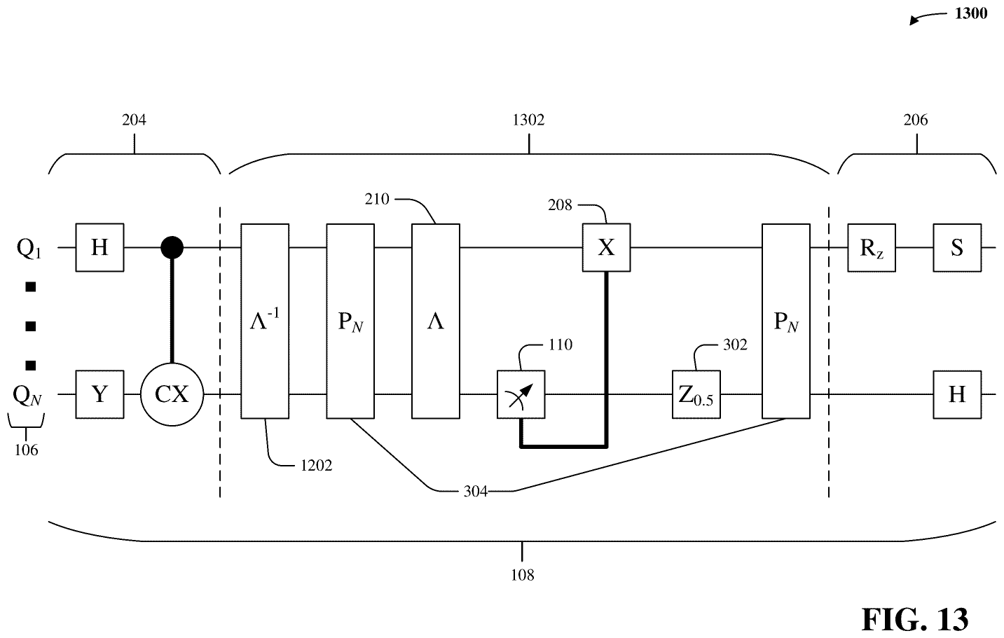

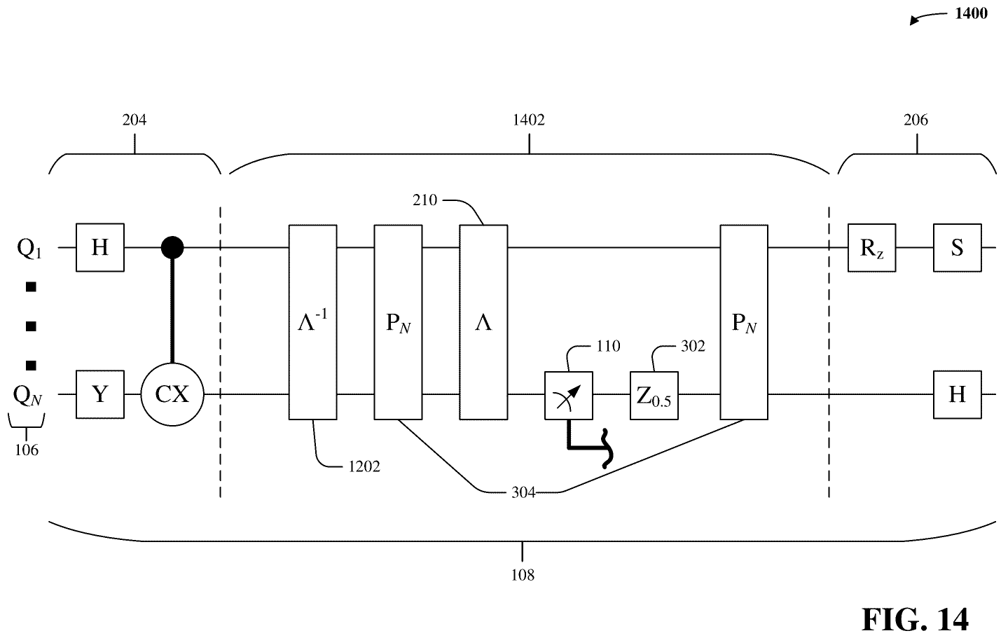

In various embodiments, as mentioned above, the learning component 118 can be considered as having learned, determined, or otherwise identified the reshaped or twirled version of the noise 210 (e.g., as having learned the reshaped noise 606), upon having obtained the set of learned noise model coefficients 306. In various aspects, the mitigation component 120 can electronically mitigate the reshaped or twirled version of the noise 210 by inserting an inverse of such noise into the dynamic quantum circuit 108. More specifically, once the set of learned noise model coefficients 306 are obtained, the reshaped noise 606 (e.g., the noise 210 as flanked by the pair of twirled Pauli operators 304) can be considered as having been learned. In various instances, the mitigation component 120 can electronically invert (e.g., via any suitable matrix inversion techniques) the reshaped noise 606, thereby yielding an inverted noise operation 1202. In other words, the inverted noise operation 1202 can be considered as being whatever n-qubit quantum operation is the inverse of the reshaped noise 606 (e.g., of the noise 210 as flanked by the pair of twirled Pauli operators 304). In various cases, the mitigation component 120 can mitigate, cancel, or otherwise reduce the reshaped noise 606 (e.g., reduce the noise 210 as flanked by the pair of twirled Pauli operators 304), by inserting the inverted noise operation 1202 into the dynamic quantum circuit 108. Various non-limiting aspects are shown with respect to FIGS. 13-14.

FIGS. 13-14 illustrate example, non-limiting block diagrams 1300 and 1400 of the dynamic quantum circuit 108 after the inverted noise operation 1202 is inserted in accordance with one or more embodiments described herein.

First, consider FIG. 13. As shown, the at least one layer 204 and the at least one layer 206 of the dynamic quantum circuit 108 can remain unchanged. However, as also shown, the mitigation component 120 can change the mid-circuit non-unitary layer 202 into a mid-circuit non-unitary layer 1302.

In various aspects, the mid-circuit non-unitary layer 1302 can comprise the mid-circuit non-unitary operation 110, the classically-controlled quantum gate 208, and the noise 210, just like the mid-circuit non-unitary layer 202. In various instances, the mitigation component 120 can insert into the mid-circuit non-unitary layer 1302 the probabilistic Pauli-Z gate 302 and the pair of twirled Pauli operators 304. However, this is a mere non-limiting example. In some cases, the mitigation component 120 can omit the probabilistic Pauli-Z gate 302. Moreover, in various aspects, the mitigation component 120 can insert into the mid-circuit non-unitary layer 1302 the inverted noise operation 1202 (denoted by “Λ⁻¹”). Again, the inverted noise operation 1202 can be considered as an n-qubit quantum operation that performs the inverse of the reshaped or twirled version of the noise 210 (e.g., that performs the inverse of the reshaped noise 606). Accordingly, the mitigation component 120 can position or locate the inverted noise operation 1202 before (e.g., upstream of) the reshaped or twirled version of the noise 210 (e.g., can position or locate the inverted noise operation 1202 before the first or most upstream one of the pair of twirled Pauli operators 304). Thus, when the dynamic quantum circuit 108 is executed, the inverted noise operation 1202 can eliminate or otherwise reduce effects of the noise 210.

As shown in FIG. 13, the classically-controlled quantum gate 208 can, in some embodiments, be located or positioned between the pair of twirled Pauli operators 304. Note that this can be the case regardless of whether the learning component 118 obtains the set of learned noise model coefficients 306 by utilizing the quantum circuit segment 400 or the quantum circuit segment 500. However, this is a mere non-limiting example. In some cases, the classically-controlled quantum gate 208 can be positioned or located not in between the pair of twirled Pauli operators 304. In particular, the classically-controlled quantum gate 208 can be within the mid-circuit non-unitary layer 1302 but can be after the second or most downstream one of the pair of twirled Pauli operators 304. In yet other cases, the classically-controlled quantum gate 208 can be omitted altogether, as shown with respect to FIG. 14. Indeed, as shown in FIG. 14, the mitigation component 120 can cause the dynamic quantum circuit 108 to, in various embodiments, comprise a mid-circuit non-unitary layer 1402 instead of the mid-circuit non-unitary layer 1302. In various aspects, the mid-circuit non-unitary layer 1402 can be identical to the mid-circuit non-unitary layer 1302, except that the classically-controlled quantum gate 208 can be omitted or otherwise removed. After all, in various embodiments, it can nevertheless be useful to implement a mid-circuit qubit measurement even in the absence of feedforward (e.g., even if such mid-circuit qubit measurement is not used to classically control a quantum gate).

In any case, the mitigation component 120 can ameliorate the effects of the noise 210 by inserting the inverted noise operation 1202 into the dynamic quantum circuit 108.

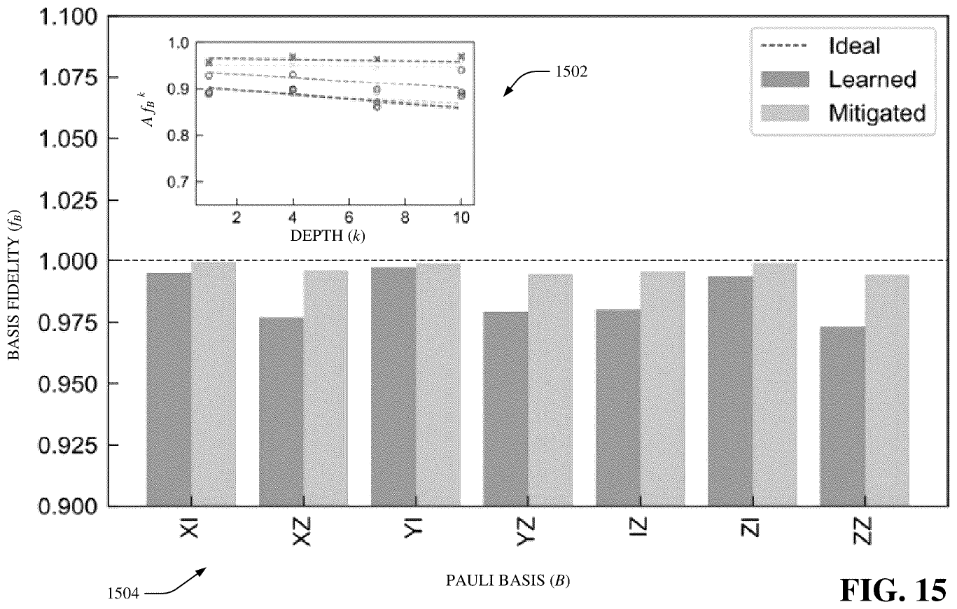

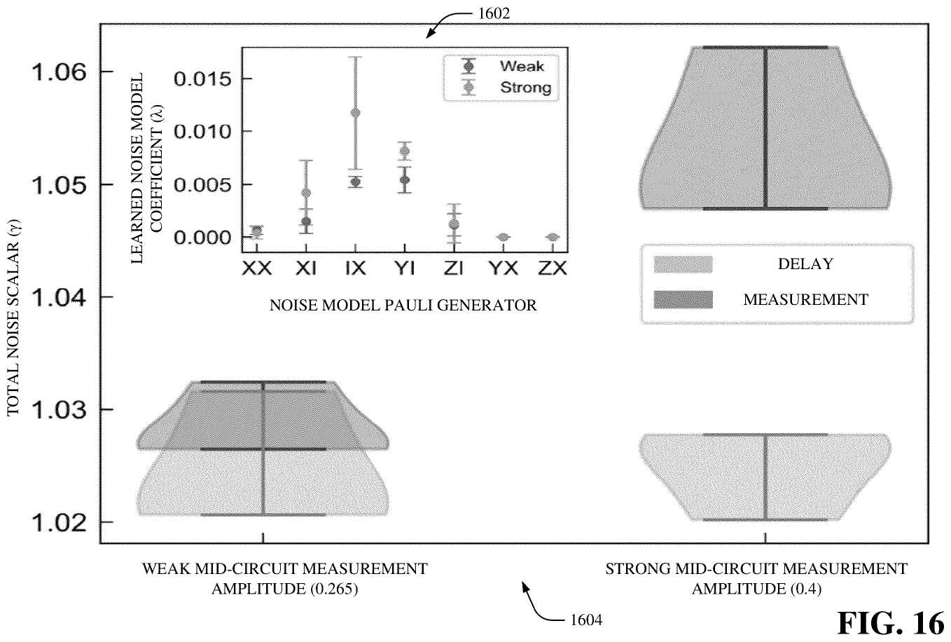

FIGS. 15-16 illustrate example, non-limiting experimental results in accordance with one or more embodiments described herein.

First, consider FIG. 15. As mentioned above, the present inventors performed various experiments in which they reduced to practice various embodiments described herein. As mentioned above, during such experiments, the following parameters were implemented: n=2; the mid-circuit non-unitary operation 110 was a mid-circuit qubit measurement on a first qubit; the classically-controlled quantum gate 208 was performed on a second qubit that was not directly coupled to the first qubit; the set of noise model Pauli generators 602 was the 7-element set given by

$$\{ I ⊗ X , X ⊗ I , X ⊗ X , Y ⊗ I , Y ⊗ X , Z ⊗ I , Z ⊗ X \} ;$$

and the set of Pauli bases 802 was the 7-element set given by

$$\{ X ⊗ I , X ⊗ z , Y ⊗ I , Y ⊗ Z , I ⊗ Z , Z ⊗ I , Z ⊗ Z \} .$$

As also mentioned above, the learned noise model coefficients that were obtained are shown in the graph 1104. Those learned noise model coefficients were utilized to compute an inverse noise operation (e.g., 1202). To valid such inverse noise operation, a new quantum circuit segment was created, where such new quantum circuit segment was in accordance with FIGS. 4-5, and where such new quantum circuit segment further had the inverse noise operation positioned or located before the mid-circuit non-unitary operation 110 (e.g., before the first or most upstream one of the pair of twirled Pauli operators 304). In accordance with FIGS. 7-10, a plurality of sets of observable expectation values were obtained using the new quantum circuit segment, exponential decay curves were fitted accordingly, as shown in a graph 1502, and basis fidelities were then extracted from the fitted exponential decay curves for the seven Pauli bases. As shown in a graph 1504, the basis fidelities that were obtained after implementation of the inverted noise operation (denoted as “mitigated”) were significantly closer to unity across all seven of the Pauli bases, as compared to the basis fidelities that were obtained before implementation of the inverted noise operation (denoted as “learned”). These experimental results show that various embodiments described herein successfully mitigated noise associated with a mid-circuit non-unitary operation (e.g., a mid-circuit qubit measurement with feedforward to a classically-controlled quantum gate).

Now, consider FIG. 16. To further validate various embodiments described herein, the present inventors conducted various embodiments (in accordance with the two-qubit system mentioned in the above experiments) where noise model coefficients were obtained for a mid-circuit qubit measurement, and where an amplitude of that mid-circuit qubit measurement was varied between weak and strong. FIG. 16 includes a graph 1602 that illustrates the learned noise model coefficients for each of the seven noise model Pauli generators that were utilized. As shown, the learned noise model coefficients tended to increase (especially for the X⊗I, I⊗X, and Y⊗I generators) with stronger measurement amplitudes. Furthermore, FIG. 16 includes a graph 1604 that shows how a total noise scalar (denoted as “γ”) varies with mid-circuit measurement amplitude, where γ=exp(2 Σ_{g∈G}λ_{g}), where G can be an index set corresponding to the noise model Pauli generators, and where λ_{g} can be the learned noise model coefficient corresponding to the g-th noise model Pauli generator. As shown, the total noise scalar significantly increases with mid-circuit measurement amplitude. This experimental result can be considered as further validating various embodiments described herein.

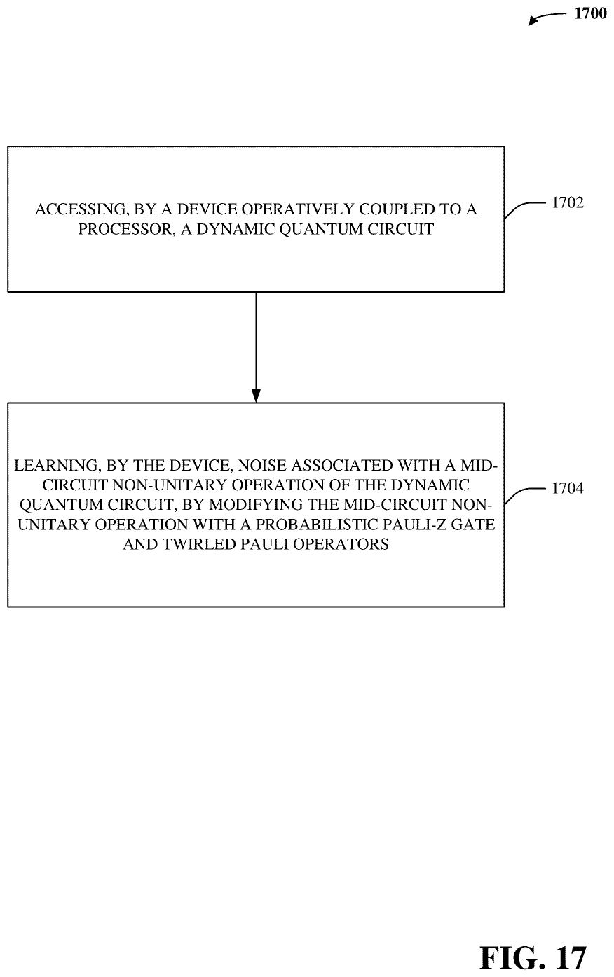

FIG. 17 illustrates a flow diagram of an example, non-limiting computer-implemented method 1700 that can facilitate noise learning in dynamic quantum circuits in accordance with one or more embodiments described herein. In various cases, the computer-implemented method 1700 can be facilitated by the dynamic circuit noise learning and mitigation system 102.

In various embodiments, act 1702 can comprise accessing, by a device (e.g., via 116) operatively coupled to a processor (e.g., 112), a dynamic quantum circuit (e.g., 104).

In various aspects, act 1704 can comprise learning, by the device (e.g., via 118), noise (e.g., 210) associated with a mid-circuit non-unitary operation (e.g., 110) of the dynamic quantum circuit, by modifying the mid-circuit non-unitary operation with a probabilistic Pauli-Z gate (e.g., 302) and twirled Pauli operators (e.g., 304).

Although not explicitly shown in FIG. 17, the mid-circuit non-unitary operation can comprise a mid-circuit qubit measurement that feeds forward to at least one classically-controlled quantum gate (e.g., 208). In some cases, the at least one classically-controlled quantum gate can be between the twirled Pauli operators (e.g., as shown in FIG. 5). In other cases, the at least one classically-controlled quantum gate can be not between the twirled Pauli operators (e.g., as shown in FIG. 4).

Although not explicitly shown in FIG. 17, the learning the noise can comprise: repeatedly executing, by the device (e.g., via 118) and across both a set of Pauli bases (e.g., 802) and a set of repetition depths (e.g., 804), the mid-circuit non-unitary operation as modified with the probabilistic Pauli-Z gate and the twirled Pauli operators; and extracting, by the device (e.g., via 118) and based on such repeated executions, a set of basis fidelities (e.g., 902) respectively corresponding to the set of Pauli bases (e.g., as shown with respect to FIGS. 7-9).

Although not explicitly shown in FIG. 17, the learning the noise can comprise: inverting, by the device (e.g., via 118), the set of basis fidelities via commutation relations (e.g., M) defined between the set of Pauli bases and a set of Pauli generators (e.g., 602) associated with the noise.

Although not explicitly shown in FIG. 17, the computer-implemented method 1700 can comprise: mitigating, by the device (e.g., via 120), the noise by inserting an inverse (e.g., 1202) of the noise into the dynamic quantum circuit.

Note that, when the mid-circuit non-unitary operation 110 is a mid-circuit qubit measurement, various embodiments described herein can be considered or otherwise referred to as measurement-based probabilistic error cancellation (e.g., mPEC).

Furthermore, note that, when the mid-circuit non-unitary operation 110 is a mid-circuit qubit measurement, the dynamic circuit noise learning and mitigation system 102 can, in various aspects, electronically flip whatever classical bit is measured by the mid-circuit non-unitary operation 110 if the pair of twirled Pauli operators 304 apply a Pauli-X gate or a Pauli-Y gate to whatever qubit on which the mid-circuit non-unitary operation is applied (e.g., qubit 106(n) in the non-limiting examples shown in the figures). However, such flipping of the measured classical bit can be omitted if the pair of twirled Pauli operators 304 instead apply a Pauli-Z gate or an identity gate to whatever qubit on which the mid-circuit non-unitary operation is applied (e.g., qubit 106(n) in the non-limiting examples shown in the figures).

Various embodiments described herein can be considered as a computerized tool for learning or mitigating noise caused by mid-circuit non-unitary operations. Such embodiments can be applied regardless of qubit connectivity and can be scaled to qubit lattices of any suitable sizes. Such embodiments certainly constitute concrete and tangible improvements in the field of dynamic quantum circuits.

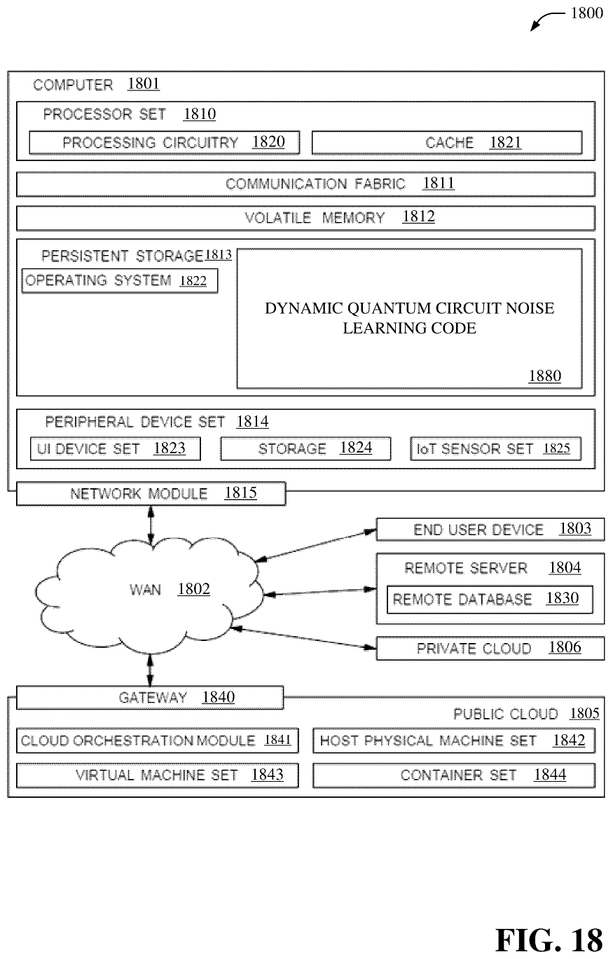

FIG. 18 and the following discussion are intended to provide a brief, general description of a suitable computing environment 1800 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1800 contains an example of an environment for the execution of at least some of the computer code involved in performing the inventive methods, such as dynamic quantum circuit noise learning code 1880. In addition to block 1880, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1880, as identified above), peripheral device set 1814 (including user interface (UI), device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method can be distributed among multiple computers or between multiple locations. On the other hand, in this presentation of computing environment 1800, detailed discussion is focused on a single computer, specifically computer 1801, to keep the presentation as simple as possible. Computer 1801 can be located in a cloud, even though it is not shown in a cloud in FIG. 18. On the other hand, computer 1801 is not required to be in a cloud except to any extent as can be affirmatively indicated.

PROCESSOR SET 1810 includes one, or more, computer processors of any type now known or to be developed in the future. Processing circuitry 1820 can be distributed over multiple packages, for example, multiple, coordinated integrated circuit chips. Processing circuitry 1820 can implement multiple processor threads or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set can be located “off chip.” In some computing environments, processor set 1810 can be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods can be stored in block 1880 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1812 is any type of volatile memory now known or to be developed in the future. Examples include dynamic type random access memory (RAM) or static type RAM. Typically, the volatile memory is characterized by random access, but this is not required unless affirmatively indicated. In computer 1801, the volatile memory 1812 is located in a single package and is internal to computer 1801, but, alternatively or additionally, the volatile memory can be distributed over multiple packages or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 or directly to persistent storage 1813. Persistent storage 1813 can be a read only memory (ROM), but typically at least a portion of the persistent storage allows writing of data, deletion of data and re-writing of data. Some familiar forms of persistent storage include magnetic disks and solid-state storage devices. Operating system 1822 can take several forms, such as various known proprietary operating systems or open-source Portable Operating System Interface type operating systems that employ a kernel. The code included in block 1880 typically includes at least some of the computer code involved in performing the inventive methods.

PERIPHERAL DEVICE SET 1814 includes the set of peripheral devices of computer 1801. Data communication connections between the peripheral devices and the other components of computer 1801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1823 can include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 can be persistent or volatile. In some embodiments, storage 1824 can take the form of a quantum computing storage device for storing data in the form of qubits. In embodiments where computer 1801 is required to have a large amount of storage (for example, where computer 1801 locally stores and manages a large database) then this storage can be provided by peripheral storage devices designed for storing large amounts of data, such as a storage area network (SAN) that is shared by multiple, geographically distributed computers. IoT sensor set 1825 is made up of sensors that can be used in Internet of Things applications. For example, one sensor can be a thermometer and another sensor can be a motion detector.

NETWORK MODULE 1815 is the collection of computer software, hardware, and firmware that allows computer 1801 to communicate with other computers through WAN 1802. Network module 1815 can include hardware, such as modems or Wi-Fi signal transceivers, software for packetizing or de-packetizing data for communication network transmission, or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801) and can take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 can be a client device, such as thin client, heavy client, mainframe computer or desktop computer.

REMOTE SERVER 1804 is any computer system that serves at least some data or functionality to computer 1801. Remote server 1804 can be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data can be provided to computer 1801 from remote database 1830 of remote server 1804.

PUBLIC CLOUD 1805 is any computer system available for use by multiple entities that provides on-demand availability of computer system resources or other computer capabilities, especially data storage (cloud storage) and computing power, without direct active management by the scale. The direct and active management of the computing resources of public cloud 1805 is performed by the computer hardware or software of cloud orchestration module 1841. The computing resources provided by public cloud 1805 are typically implemented by virtual computing environments that run on various computers making up the computers of host physical machine set 1842, which is the universe of physical computers in or available to public cloud 1805. The virtual computing environments (VCEs) typically take the form of virtual machines from virtual machine set 1843 or containers from container set 1844. It is understood that these VCEs can be stored as images and can be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware and firmware allowing public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1805 and private cloud 1806 are both part of a larger hybrid cloud.

The herein disclosure describes non-limiting examples of various embodiments of the subject innovation. For ease of description or explanation, various portions of the herein disclosure utilize the term “each” when discussing various embodiments of the subject innovation. Such usages of the term “each” are non-limiting examples. In other words, when the herein disclosure provides a description that is applied to “each” of some particular object or component, it should be understood that this is a non-limiting example of various embodiments of the subject innovation, and it should be further understood that, in various other embodiments of the subject innovation, it can be the case that such description applies to fewer than “each” of that particular object or component.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, wherein the computer-executable components comprise:
a learning component that learns noise associated with a mid-circuit non-unitary operation of a dynamic quantum circuit, by modifying the mid-circuit non-unitary operation with a probabilistic Pauli-Z gate and twirled Pauli operators.

2. The system of claim 1, wherein the mid-circuit non-unitary operation comprises a mid-circuit qubit measurement that feeds forward to at least one classically-controlled quantum gate.

3. The system of claim 2, wherein the at least one classically-controlled quantum gate is between the twirled Pauli operators.

4. The system of claim 2, wherein the at least one classically-controlled quantum gate is not between the twirled Pauli operators.

5. The system of claim 1, wherein the learning component learns the noise by repeatedly executing, across a set of Pauli bases and across a set of repetition depths, the mid-circuit non-unitary operation as modified with the probabilistic Pauli-Z gate and the twirled Pauli operators and extracting, based on such repeated executions, a set of basis fidelities respectively corresponding to the set of Pauli bases.

6. The system of claim 5, wherein the learning component learns the noise associated with the mid-circuit non-unitary operation, by inverting the set of basis fidelities via commutation relations defined between the set of Pauli bases and a set of Pauli generators associated with the noise.

7. The system of claim 1, wherein the computer-executable components further comprise:
a mitigation component that mitigates the noise by inserting an inverse of the noise into the dynamic quantum circuit.

8. A computer-implemented method, comprising:
learning, by a device operatively coupled to a processor, noise associated with a mid-circuit non-unitary operation of a dynamic quantum circuit, by modifying the mid-circuit non-unitary operation with a probabilistic Pauli-Z gate and twirled Pauli operators.

9. The computer-implemented method of claim 8, wherein the mid-circuit non-unitary operation comprises a mid-circuit qubit measurement that feeds forward to at least one classically-controlled quantum gate.

10. The computer-implemented method of claim 9, wherein the at least one classically-controlled quantum gate is between the twirled Pauli operators.

11. The computer-implemented method of claim 9, wherein the at least one classically-controlled quantum gate is not between the twirled Pauli operators.

12. The computer-implemented method of claim 8, wherein the learning the noise comprises:
repeatedly executing, by the device and across both a set of Pauli bases and a set of repetition depths, the mid-circuit non-unitary operation as modified with the probabilistic Pauli-Z gate and the twirled Pauli operators; and
extracting, by the device and based on such repeated executions, a set of basis fidelities respectively corresponding to the set of Pauli bases.

13. The computer-implemented method of claim 12, wherein the learning the noise comprises:
inverting, by the device, the set of basis fidelities via commutation relations defined between the set of Pauli bases and a set of Pauli generators associated with the noise.

14. The computer-implemented method of claim 8, further comprising:
mitigating, by the device, the noise by inserting an inverse of the noise into the dynamic quantum circuit.

15. A computer program product for facilitating noise learning in dynamic quantum circuits, the computer program product comprising a non-transitory computer-readable memory having program instructions embodied therewith, the program instructions executable by a processor to cause the processor to:
learn noise associated with a mid-circuit non-unitary operation of a dynamic quantum circuit, by modifying the mid-circuit non-unitary operation with a probabilistic Pauli-Z gate and twirled Pauli operators.

16. The computer program product of claim 15, wherein the mid-circuit non-unitary operation comprises a mid-circuit qubit measurement that feeds forward to at least one classically-controlled quantum gate.

17. The computer program product of claim 16, wherein the at least one classically-controlled quantum gate is between the twirled Pauli operators.

18. The computer program product of claim 16, wherein the at least one classically-controlled quantum gate is not between the twirled Pauli operators.

19. The computer program product of claim 15, wherein the program instructions are further executable to cause the processor to:
repeatedly execute, across a set of Pauli bases and across a set of repetition depths, the mid-circuit non-unitary operation as modified with the probabilistic Pauli-Z gate and the twirled Pauli operators; and
extract, based on such repeated executions, a set of basis fidelities respectively corresponding to the set of Pauli bases.

20. The computer program product of claim 19, wherein the program instructions are further executable to cause the processor to:
invert the set of basis fidelities via commutation relations defined between the set of Pauli bases and a set of Pauli generators associated with the noise.
